(19) United States
(12) Patent Application Publication
(10) Pub. No.: US 2008/0059547 A1
(43) Pub. Date: Mar. 6, 2008

(54) Method and Computer System for Extrapolating Changes in a Self-Consistent Solution Driven by an External Parameter

(75) Inventor: Jeremy Taylor, Farum (DK)

Correspondence Address: GIFFORD, KRASS, SPRINKLE,ANDERSON & CITKOWSKI, P.C, PO BOX 7021, TROY, MI, 48007-7021, US

(73) Assignee: Atomistix A/S, Copenhagen O (DK)

(21) Appl. No.: 11/571,914

(22) PCT Filed: Jul. 5, 2005
(86) PCT No.: PCT/DK05/00470

§ 371 Date: Mar. 31, 2007

Related U.S. Application Data
(60) Provisional application No. 60/587,161, filed on Jul. 12, 2004.

(51) Int. Cl. G06F 17/10; G06F 17/17

(52) U.S. Cl. 708/290; 703/2; 977/839

(57) ABSTRACT

The invention relates to a method an computer system for using extrapolation analysis to express an approximate self-consistent solution or a change in a self-consistent solution based on a change in the value of one or more external parameters, said self-consistent solution being used in a model of a system having at least two probes or electrodes, which model is based on an electronic structure calculation comprising a self-consistent determination of an effective one-electron potential energy function and/or an effective one-electron Hamiltonian. The method of the invention comprises the steps of: determining a first self-consistent solution to a selected function for a first value of a first external parameter by use of self-consistent loop calculation; determining a second self-consistent solution to the selected function for a second value of the first selected external parameter by use of self-consistent loop calculation, said second value of the first selected external parameter being different to the first value of the first selected external parameter; and expressing an approximate self-consistent solution or a change in the self-consistent solution for the selected function for at least one selected value of the first selected external parameter by use of extrapolation based on at least the determined first and second self-consistent solutions and the first and second values of the first selected external parameter.

### FIELD OF THE INVENTION

The present invention relates to methods and systems for using extrapolation analysis or techniques to express an approximate self-consistent solution or a change in a self-consistent solution based on a change in the value of one or more external parameters. The self-consistent solution may be used in a model of a system or nano-scale system having at least two probes or electrodes, and the model may be based on an electronic structure calculation comprising a self-consistent determination of an effective one-electron potential energy function and/or an effective one-electron Hamiltonian.

### BACKGROUND OF THE INVENTION

Most common examples of methods within the field of atomic scale modelling, where the modelling is based on electronic structure calculations that require a self-consistent determination of an effective one-electron potential energy function are Density Functional Theory (DFT) and Hartree-Fock (HF) theory. Many applications of DFT are studies of how a system responds when an external parameter is varied. In such studies, it is necessary to perform a self-consistent calculation for each value of the external parameter, and this can be very time consuming. An important application is the calculation of the current-voltage (I-U) characteristics of a nano-scale device. An example of such a calculation is given in Stokbro, Computational Materials Science 27, 151 (2003), where the I-U characteristics of a Di-Thiol-Phenyl (DTP) molecule coupled with gold surfaces is calculated. The system is illustrated in FIG. 2, and the calculation follows the steps outlined in flowcharts 2 and 3 shown in FIGS. 5 and 6. The calculation is very computationally demanding, due to the self-consistent loop for each voltage.

It is an objective of the present invention is to provide an efficient and reasonable accurate method for determining a change in a self-consistent solution caused by a variation of one or more external parameters.

### SUMMARY OF THE INVENTION

According to the present invention there is provided a method of using extrapolation analysis or technique to express an approximate self-consistent solution or a change in a self-consistent solution based on a change in the value of one or more external parameters, said self-consistent solution being used in a model of a system having at least two probes or electrodes, which model is based on an electronic structure calculation comprising a self-consistent determination of an effective one-electron potential energy function and/or an effective one-electron Hamiltonian, the method comprising:

determining a first self-consistent solution to a selected function for a first value of a first external parameter by use of self-consistent loop calculation;

determining a second self-consistent solution to the selected function for a second value of the first selected external parameter by use of self-consistent loop calculation, said second value of the first selected external parameter being different to the first value of the first selected external parameter; and

expressing an approximate self-consistent solution or a change in the self-consistent solution for the selected function for at least one selected value of the first selected external parameter by use of extrapolation based on at least the determined first and second self-consistent solutions and the first and second values of the first selected external parameter. Here, the approximate self-consistent solution or change in the self-consistent solution may be expressed by use of linear extrapolation.

According to an embodiment of the invention the method may further comprise that a third self-consistent solution to the selected function is determined for a third value of the first selected external parameter by use of self-consistent loop calculation, said third value of the first selected external parameter being different to the first and second values of the first selected external parameter. Here, the approximate self-consistent solution or change in the self-consistent solution for the selected function for at least one selected value of the first selected external parameter may be expressed by use of extrapolation based on at least the determined first, second and third self-consistent solutions and the first, second and third values of the first selected external parameter. Here, it is preferred that the approximate self-consistent solution or change in the self-consistent solution is expressed by use of second order extrapolation.

It is preferred that the system being modelled is a nano-scale device or a system comprising a nano-scale device. It is also preferred that the modelling of the system comprises providing one or more of the external parameters as inputs to said probes or electrodes.

According to an embodiment of the invention the system being modelled is a two-probe system and the external parameter is a voltage bias, U, across said two probes or electrodes, said two-probe system being modelled as having two substantially semi-infinite probes or electrodes being coupled to each other via an interaction region.

It is also within an embodiment of the invention that the system being modelled is a three-probe system with three probes or electrodes and the external parameters are a first selected parameter and a second selected parameter being of the same type as the first selected parameter. Here, the system being modelled may be a three-probe system with three probes or electrodes and the external parameters are a first voltage bias, U1, across a first and a second of said electrodes and a second voltage bias, U2, across a third and the first of said electrodes, said three-probe system being modelled as having three substantially semi-infinite electrodes being coupled to each other via an interaction region.

When the system being modelled is a three-probe system, the method of the invention may further comprise:

determining a fourth self-consistent solution to the selected function for a first value of the second selected external parameter by use of self-consistent loop calculation,

determining a fifth self-consistent solution to the selected function for a second value of the second selected external parameter by use of self-consistent loop calculation, said second value of the second selected external parameter being different to the first value of the second selected external parameter; and

wherein said expressing of the approximate self-consistent solution or change in the self-consistent solution for the selected function is expressed for the selected value of the first selected external parameter and a selected value of the second selected external parameter by use of extrapolation based on at least the determined first and second self-consistent solutions together with the first and second values of the first selected external parameter, and further based on at least the determined fourth and fifth self-consistent solutions together with the first and second values of the second selected external parameter. Here, the approximate self-consistent solution or change in the self-consistent solution may be expressed by use of linear extrapolation.

The above described method of the invention provided for the three-probe system may further comprise that a sixth self-consistent solution to the selected function is determined for a third value of the second selected external parameter by use of self-consistent loop calculation, said third value of the second selected external parameter being different to the first and second values of the second selected external parameter; and that said expressing of the approximate self-consistent solution or change in the self-consistent solution for the selected function is expressed for the selected value of the first selected external parameter and the selected value of the second selected external parameter by use of extrapolation based on at least the determined first, second and third self-consistent solutions together with the first, second and third values of the first selected external parameter, and further based on at least the determined fourth, fifth and sixth self-consistent solutions together with the first, second and third values of the second selected external parameter. Here, the approximate self-consistent solution or change in the self-consistent solution may be expressed by use of second order extrapolation.

For the methods of the invention provided for the three-probe system, the first value of the second selected external parameter may be equal to the first value of the first selected external parameter.

According to the present invention it is preferred that the selected function is selected from the functions represented by: the effective one-electron potential energy function, the effective one-electron Hamiltonian, and the electron density. Here, it is again preferred that the selected function is the effective one-electron potential energy function or the effective one-electron Hamiltonian and the self-consistent loop calculation is based on the Density Functional Theory, DFT, or the Hartree-Fock Theory, HF.

According to an embodiment of the invention, the self-consistent loop calculation may be based on a loop calculation including the steps of:

a) selecting a value of the electron density for a selected region of the model of the system,

b) determining the effective one-electron potential energy function for the selected electron density and for a selected value of the external parameter,

c) calculating a value for the electron density corresponding to the determined effective one-electron potential energy function,

d) comparing the selected value of the electron density with the calculated value of the electron density, and if the selected value and the calculated value of electron density are equal within a given numerical accuracy, then

e) defining the solution to the effective one-electron potential energy function as the self-consistent solution to the effective one-electron potential energy function, and if not, then

f) selecting a new value of the electron density and repeat steps b)-f) until the selected value and the calculated value of electron density are equal within said given numerical accuracy. Here, the self-consistent solution to the effective one-electron potential energy function may be determined for the probe or electrode regions of the system.

For embodiments where the self-consistent solution to the effective one-electron potential energy function is determined for the probe or electrode regions of the system, it is also preferred that Green's functions are constructed or determined for each of the probe or electrode regions based on the corresponding determined self-consistent solution to the effective one-electron potential energy function.

It is within an embodiment of the method of the invention that the selected function is the effective one-electron Hamiltonian for an interaction region of the system, and the determination of a second self-consistent solution to the effective one-electron Hamiltonian of the interaction region of the system comprises the step of calculating a corresponding self-consistent solution to the effective one-electron potential energy function for the interaction region at a given value of the first selected external parameter. Here, the determination of a second self-consistent solution to the effective one-electron Hamiltonian may be based on a loop calculation including the steps of:

aa) selecting a value of the electron density for the interaction region of the system,

bb) determining the effective one-electron potential energy function for the selected electron density for a given value of the selected external parameter,

cc) determining a solution to the effective one-electron Hamiltonian for the interaction region based on the in step bb) determined effective one-electron potential energy function,

dd) determining a solution to Green's function for the interaction region based on the in step cc) determined solution to the effective one-electron Hamiltonian,

ee) calculating a value for the electron density corresponding to the determined Green's function for the interaction region,

ff) comparing the selected value of the electron density with the calculated value of the electron density, and if the selected value and the calculated value of electron density are equal within a given numerical accuracy, then

gg) defining the solution to the effective one-electron Hamiltonian as the self-consistent solution to the effective one-electron Hamiltonian, and if not, then

hh) selecting a new value of the electron density and repeat steps bb)-hh) until the selected value and the calculated value of electron density are equal within said given numerical accuracy.

According to an embodiment of the invention the selected function may be the effective one-electron Hamiltonian being represented by a Hamiltonian matrix with each element of said matrix being a function having an approximate self-consistent solution or a change in the self-consistent solution being expressed by use of a corresponding extrapolation expression,

The method of the present invention also covers an embodiment wherein the selected function is the effective one-electron Hamiltonian and the external parameter is a voltage bias across two probes of the system, an wherein a first and a second self-consistent solution is determined for the effective one-electron Hamiltonian for selected first and second values, respectively, of the external voltage bias, whereby an extrapolation expression is obtained to an approximate self-consistent solution for the effective one-electron Hamiltonian when the external voltage bias is changed, said method further comprising: determining the electrical current between the two probes of the system for a number of different values of the applied voltage bias using the obtained extrapolation expression, which expresses the approximate self-consistent solution or change in the self-consistent solution for the effective one-electron Hamiltonian. Here, the obtained extrapolation expression may be a linear expression. The electrical current may be determined for a given range of the external voltage bias and for a given voltage step in the external voltage bias, and the electrical current may be determined using the following loop:

aaa) determining the current for the lowest voltage within the given range of the external voltage bias,

bbb) increasing the voltage bias by the given voltage step,

ccc) determining the current for the new increased voltage bias,

ddd) repeating steps bbb) and ccc) until the new increased voltage bias is larger than the highest voltage of the given range of the voltage bias.

It is also within an embodiment of the invention that the system being modelled is a two probe system and that the selected function is the effective one-electron Hamiltonian and the external parameter is a voltage bias across two probes of the system, said method comprising:

dividing a determined voltage range for the external voltage bias in at least a first and a second voltage range,

determining for the first and second voltage ranges a maximum and a minimum self-consistent solution to the effective one-electron Hamiltonian corresponding to the maximum and minimum values of said voltage ranges,

obtaining a first extrapolation expression to the approximate self-consistent solution for the effective one-electron Hamiltonian when the external voltage bias is changed, said first extrapolation expression being based on the determined maximum and minimum self-consistent solutions for the first voltage range and the maximum and minimum voltage values of the first voltage range,

obtaining a second extrapolation expression to the approximate self-consistent solution for the effective one-electron Hamiltonian when the external voltage bias is changed, said second extrapolation expression being based on the determined maximum and minimum self-consistent solutions for the second voltage range and the maximum and minimum voltage values of the second voltage range,

determining the electrical current between the two probes of the system for a number of different values of the applied voltage bias within the voltage range given by the minimum and maximum voltage of the first voltage range using the obtained first extrapolation expression, and

determining the electrical current between the two probes of the system for a number of different values of the applied voltage bias within the voltage range given by the minimum and maximum voltage of the second voltage range using the obtained second extrapolation expression. Here, the obtained first and second extrapolation expressions may be first and second linear expressions, respectively. It is also within an embodiment of the method of the invention that the determined voltage range is divided in at least three voltage ranges, and that the method further comprises:

determining for the third voltage range a maximum and a minimum self-consistent solution to the effective one-electron Hamiltonian corresponding to the maximum and minimum values of the third voltage range,

obtaining a third extrapolation expression to the approximate self-consistent solution for the effective one-electron Hamiltonian when the external voltage bias is changed, said third extrapolation expression being based on the determined maximum and minimum self-consistent solutions for the third voltage range and the maximum and minimum voltage values of the third voltage range, and

determining the electrical current between the two probes of the system for a number of different values of the applied voltage bias within the voltage range given by the minimum and maximum voltage of the third voltage range using the obtained third linear extrapolation. Also here, the obtained third extrapolation expression may be a third linear extrapolation expression.

The method of the present invention also covers an embodiment where the system being modelled is a two-probe system and wherein the selected function is the effective one-electron Hamiltonian and the external parameter is a voltage bias across two probes of the system, an wherein a first and a second self-consistent solution is determined for the effective one-electron Hamiltonian for selected first and second values, respectively, of the external voltage bias, with said second value being higher than the selected first value of the voltage bias, whereby a first extrapolation expression is obtained to an approximate self-consistent solution for the effective one-electron Hamiltonian when the external voltage bias is changed, said method further comprising:

aaaa) selecting a voltage range having a minimum value and a maximum value for the external voltage bias in order to determine the electrical current between the two probes of the system for a number of different values of the applied voltage bias within said range,

bbbb) determining a maximum self-consistent solution to the effective one-electron Hamiltonian for the selected maximum value of the external voltage bias by use of self-consistent loop calculation,

cccc) determining the electrical current between the two probes of the system for the maximum value of the voltage bias based on the corresponding determined maximum self-consistent solution,

dddd) determining the electrical current between the two probes of the system for the selected maximum value of the voltage bias based on the obtained first extrapolation expression,

eeee) comparing the current values determined in steps cccc) and dddd), and if they are equal within a given numerical accuracy, then

ffff) determining the electrical current between the two probes of the system for a number of different values of the applied voltage bias within the voltage range given by the selected first voltage value and the maximum voltage value using an extrapolation expression for an approximate self-consistent solution for the effective one-electron Hamiltonian when the external voltage bias is changed. Here, the obtained first extrapolation expression may be a first linear extrapolation expression, and linear extrapolation may be used in step ffff) for expressing the approximate self-consistent solution for the effective one-electron Hamiltonian when the external voltage bias is changed. It is within a preferred embodiment that a maximum extrapolation expression is obtained to the approximate self-consistent solution for the effective one-electron Hamiltonian, said maximum extrapolation expression being based on the determined first and maximum self-consistent solutions and the first voltage bias and the maximum value of the voltage bias, and wherein said maximum extrapolation expression is used when determining the current in step ffff). The maximum extrapolation expression may be a maximum linear extrapolation expression. It is also preferred that when in step eeee) the current values determined in steps cccc) and dddd), are not equal within the given numerical accuracy, then the method further comprises:

gggg) selecting a new maximum value of the external voltage bias between the first value and the previous maximum value,

hhhh) repeating steps bbbb) to hhhh) until the in steps cccc) and dddd) determined current values are equal within said given numerical accuracy. According to an embodiment of the invention, the method may further comprise the steps:

iiii) determining a minimum self-consistent solution to the effective one-electron Hamiltonian for the selected minimum value of the external voltage bias by use of self-consistent loop calculation,

jjjj) determining the electrical current between the two probes of the system for the minimum value of the voltage bias based on the corresponding determined minimum self-consistent solution,

kkkk) determining the electrical current between the two probes of the system for the selected minimum value of the voltage bias based on the obtained first extrapolation expression,

llll) comparing the current values determined in steps jjjj) and kkkk), and if they are equal within a given numerical accuracy, then

mmmm) determining the electrical current between the two probes of the system for a number of different values of the applied voltage bias within the voltage range given by the selected first voltage value and the minimum voltage value using an extrapolation expression for an approximate self-consistent solution for the effective one-electron Hamiltonian when the external voltage bias is changed. Here, linear extrapolation may be used in step mmmm) for expressing the approximate self-consistent solution for the effective one-electron Hamiltonian when the external voltage bias is changed. Also here, it is within a preferred embodiment that a minimum extrapolation expression is obtained to the approximate self-consistent solution for the effective one-electron Hamiltonian, where the minimum extrapolation expression is based on the determined first and minimum self-consistent solutions and the first voltage bias and the minimum value of the voltage bias, and wherein the minimum extrapolation expression is used when determining the current in step mmmm). Here, the minimum extrapolation expression may be a minimum linear extrapolation expression. Also here it is preferred that when in step llll) the current values determined in steps jjjj) and kkkk), are not equal within the given numerical accuracy, then the method further comprises:

nnnn) selecting a new minimum value of the external voltage bias between the first value and the previous minimum value,

oooo) repeating steps iiii) to oooo) until the in steps jjjj) and kkkk) determined current values are equal within said given numerical accuracy.

According to the present invention there is also provided a computer system for using extrapolation analysis to express an approximate self-consistent solution or a change in a self-consistent solution based on a change in the value of one or more external parameters, said self-consistent solution being used in a model of a nano-scale system having at least two probes or electrodes, which model is based on an electronic structure calculation comprising a self-consistent determination of an effective one-electron potential energy function and/or an effective one-electron Hamiltonian, said computer system comprising:

means for determining a first self-consistent solution to a selected function for a first value of a first external parameter by use of self-consistent loop calculation;

means for determining a second self-consistent solution to the selected function for a second value of the first selected external parameter by use of self-consistent loop calculation, said second value of the first selected external parameter being different to the first value of the first selected external parameter; and

means for expressing an approximate self-consistent solution or a change in the self-consistent solution for the selected function for at least one selected value of the first selected external parameter by use of extrapolation based on at least the determined first and second self-consistent solutions and the first and second values of the first selected external parameter. Here, the means for expressing the approximate self-consistent solution or change in the self-consistent solution may be adapted for expressing such solution by use of linear extrapolation.

According to an embodiment of the invention the computer system may further comprise: means for determining a third self-consistent solution to the selected function for a third value of the first selected external parameter by use of self-consistent loop calculation, said third value of the first selected external parameter being different to the first and second values of the first selected external parameter. Here, the means for expressing the approximate self-consistent solution or change in the self-consistent solution for the selected function for at least one selected value of the first selected external parameter may be adapted for expressing such solution by use of extrapolation based on at least the determined first, second and third self-consistent solutions and the first, second and third values of the first selected external parameter. Here, it is preferred that the means for expressing the approximate self-consistent solution or change in the self-consistent solution is adapted for expressing such solution by use of second order extrapolation.

For the computer system of the invention it is within an embodiment that the nano-scale system is a two-probe system and the external parameter is a voltage bias, U, across said two probes or electrodes, said two-probe system being modelled as having two substantially semi-infinite probes or electrodes being coupled to each other via an interaction region.

The computer system of the invention also covers an embodiment wherein the nano-scale system is a three-probe system with three probes or electrodes and the external parameters are a first selected parameter and a second selected parameter being of the same type as the first selected parameter. Here it is preferred that the nano-scale system is a three-probe system with three probes or electrodes and the external parameters are a first voltage bias, U1, across a first and a second of said electrodes and a second voltage bias, U2, across a third and the first of said electrodes, said three-probe system being modelled as having three substantially semi-infinite electrodes being coupled to each other via an interaction region.

Also here, when the nano-scale system being modelled is a three-probe system, the computer system of the invention may further comprise:

means for determining a fourth self-consistent solution to the selected function for a first value of the second selected external parameter by use of self-consistent loop calculation;

means for determining a fifth self-consistent solution to the selected function for a second value of the second selected external parameter by use of self-consistent loop calculation, said second value of the second selected external parameter being different to the first value of the second selected external parameter; and

wherein said means for expressing of the approximate self-consistent solution or change in the self-consistent solution for the selected function is adapted to express the approximate self-consistent solution for the selected value of the first selected external parameter and a selected value of the second selected external parameter by use of extrapolation based on the determined first and second self-consistent solutions together with the first and second values of the first selected external parameter, and further based on the determined fourth and fifth self-consistent solutions together with the first and second values of the second selected external parameter. Here, the means for expressing the approximate self-consistent solution or change in the self-consistent solution may be adapted for expressing such solution by use of linear extrapolation.

The above described computer system for modelling a three-probe system may further comprise:

means for determining a sixth self-consistent solution to the selected function for a third value of the second selected external parameter by use of self-consistent loop calculation, said third value of the second selected external parameter being different to the first and second values of the second selected external parameter. Here, the means for expressing the approximate self-consistent solution or change in the self-consistent solution for the selected function may be adapted to express the approximate self-consistent solution for the selected value of the first selected external parameter and the selected value of the second selected external parameter by use of extrapolation based on at least the determined first, second and third self-consistent solutions together with the first, second and third values of the first selected external parameter, and further based on at least the determined fourth, fifth and sixth self-consistent solutions together with the first, second and third values of the second selected external parameter. Here, the means for expressing the approximate self-consistent solution or change in the self-consistent solution may be adapted for expressing such solution by use of second order extrapolation.

For the system of the invention provided for the three-probe system, the first value of the second selected external parameter may be equal to the first value of the first selected external parameter.

Also for the computer system of the present invention it is preferred that the selected function is selected from the functions represented by: the effective one-electron potential energy function, the effective one-electron Hamiltonian, and the electron density. Here, it is again preferred that the selected function is the effective one-electron potential energy function or the effective one-electron Hamiltonian and the self-consistent loop calculation is based on the Density Functional Theory, DFT, or the Hartree-Fock Theory, HF.

According to an embodiment of the invention, the computer may further comprise means for performing a self-consistent loop calculation based on a loop calculation including the steps of:

a) selecting a value of the electron density for a selected region of the model of the nano-scale system,

b) determining the effective one-electron potential energy function for the selected electron density and for a selected value of the external parameter,

c) calculating a value for the electron density corresponding to the determined effective one-electron potential energy function,

d) comparing the selected value of the electron density with the calculated value of the electron density, and if the selected value and the calculated value of electron density are equal within a given numerical accuracy, then

e) defining the solution to the effective one-electron potential energy function as the self-consistent solution to the effective one-electron potential energy function, and if not, then

f) selecting a new value of the electron density and repeat steps b)-f) until the selected value and the calculated value of electron density are equal within said given numerical accuracy. Here, the means for performing the self-consistent loop calculation may be adapted to determine the self-consistent solution to the effective one-electron potential energy function for the probe or electrode regions of the system.

For embodiments wherein the means for performing the self-consistent loop calculation may be adapted to determine the self-consistent solution to the effective one-electron potential energy function for the probe or electrode regions of the system, it is also preferred that the computer system further comprises means for determining Green's functions for each of the probe or electrode regions based on the corresponding determined self-consistent solution to the effective one-electron potential energy function.

For the computer system of the invention it is also within an embodiment that the selected function is the effective one-electron Hamiltonian for an interaction region of the system, and the means for determining a second self-consistent solution to the effective one-electron Hamiltonian of the interaction region of the system is adapted to perform said determination by including the step of calculating a corresponding self-consistent solution to the effective one-electron potential energy function for the interaction region at a given value of the first selected external parameter. Here, the means for determination of a second self-consistent solution to the effective one-electron Hamiltonian is adapted to perform said determination based on a loop calculation including the steps of:

aa) selecting a value of the electron density for the interaction region of the system,

bb) determining the effective one-electron potential energy function for the selected electron density for a given value of the selected external parameter,

cc) determining a solution to the effective one-electron Hamiltonian for the interaction region based on the in step b) determined effective one-electron potential energy function,

dd) determining a solution to Green's function for the interaction region based on the in step c) determined solution to the effective one-electron Hamiltonian,

ee) calculating a value for the electron density corresponding to the determined Green's function for the interaction region,

ff) comparing the selected value of the electron density with the calculated value of the electron density, and if the selected value and the calculated value of electron density are equal within a given numerical accuracy, then

gg) defining the solution to the effective one-electron Hamiltonian as the self-consistent solution to the effective one-electron Hamiltonian, and if not, then

hh) selecting a new value of the electron density and repeat steps bb)-hh) until the selected value and the calculated value of electron density are equal within said given numerical accuracy.

Also the computer system of the invention covers an embodiment wherein the selected function is the effective one-electron Hamiltonian and the external parameter is a voltage bias across two probes of the system, wherein the means for determining a first and a second self-consistent solution is adapted to perform said determination for the effective one-electron Hamiltonian for selected first and second values, respectively, of the external voltage bias, and wherein the means for expressing an approximate self-consistent solution by use of extrapolation analysis is adapted to obtain an extrapolation expression to an approximate self-consistent solution for the effective one-electron Hamiltonian when the external voltage bias is changed, said computer system further comprising: means for determining the electrical current between the two probes of the system for a number of different values of the applied voltage bias using the obtained extrapolation expression, which expresses the approximate self-consistent solution or change in the self-consistent solution for the effective one-electron Hamiltonian. Here, the obtained extrapolation expression may be a linear extrapolation expression. The means for determining the electrical current may be adapted to determine the electrical current for a given range of the external voltage bias and for a given voltage step in the external voltage bias, and the means for determining the electrical current may be adapted to perform said determination using the following loop:

aaa) determining the current for the lowest voltage within the given range of the external voltage bias,

bbb) increasing the voltage bias by the given voltage step,

ccc) determining the current for the new increased voltage bias,

ddd) repeating steps bbb) and ccc) until the new increased voltage bias is larger than the highest voltage of the given range of the voltage bias.

It is also within an embodiment of the computer system of the invention that the system being modelled is a two-probe system and that the selected function is the effective one-electron Hamiltonian and the external parameter is a voltage bias across two probes of the system, and wherein the computer system further comprises:

means for dividing a determined voltage range of the external voltage bias in at least a first and a second voltage range,

means for determining for the first and second voltage ranges a maximum and a minimum self-consistent solution to the effective one-electron Hamiltonian corresponding to the maximum and minimum values of said voltage ranges,

means for obtaining a first extrapolation expression to the approximate self-consistent solution for the effective one-electron Hamiltonian when the external voltage bias is changed, said first extrapolation expression being based on the determined maximum and minimum self-consistent solutions for the first voltage range and the maximum and minimum voltage values of the first voltage range,

means for obtaining a second extrapolation expression to the approximate self-consistent solution for the effective one-electron Hamiltonian when the external voltage bias is changed, said second extrapolation expression being based on the determined maximum and minimum self-consistent solutions for the second voltage range and the maximum and minimum voltage values of the second voltage range,

means for determining the electrical current between the two probes of the system for a number of different values of the applied voltage bias within the voltage range given by the minimum and maximum voltage of the first voltage range using the obtained first extrapolation expression, and

means for determining the electrical current between the two probes of the system for a number of different values of the applied voltage bias within the voltage range given by the minimum and maximum voltage of the second voltage range using the obtained second extrapolation expression. Here, the obtained first and second extrapolation expressions may be first and second linear extrapolation expressions, respectively.

Other objects, features and advantages of the present invention will be more readily apparent from the detailed description of the preferred embodiments set forth below, taken in conjunction with the accompanying drawings.

### BRIEF DESCRIPTION OF THE DRAWINGS

FIG. 1 is a flowchart (flowchart 1) illustrating the computational steps in a self-consistent loop of the Density Functional Theory.

FIG. 2 illustrates a Benzene-Di-Thiol molecule coupled with two Gold (111) surfaces, here the gold surfaces are coupled to an external voltage source, and the electrodes have different chemical potentials μ_{L} and μ_{R}.

FIG. 3 shows the self-consistent electron density of a carbon nano-tube coupled with a gold surface, where, when being outside the interaction region, the electron density is given by the bulk density of the electrodes.

FIG. 4a shows equivalent real axis (R) and complex contours (C) that can be used for the integral of Green's function G₁(z).

FIG. 4b shows the variation of the spectral density

$$( \frac{1}{π} Im {G}_{I} ( z ) )$$

along contour C (dashed) of FIG. 4a and along the real axis R (solid) of FIG. 4a.

FIG. 5 is a flowchart (flowchart 2) showing steps required to calculate a self-consistent effective potential energy function of a two-probe system with applied voltage U using the Green's function approach, and where from the self-consistent effective one-electron potential energy function the electrical current/can be calculated.

FIG. 6 is a flowchart (flowchart 3) showing steps required for a self-consistent calculation of the I-U characteristics of a two-probe system.

FIG. 7a shows the self-consistent effective one-electron potential energy function of the system illustrated in FIG. 2 and calculated for different values of the applied voltage.

FIG. 7b shows the self-consistent effective one-electron potential energy function rescaled with the applied voltage.

FIG. 8 is a flowchart (flowchart 4) showing steps involved when using a linear extrapolation expression according to an embodiment of the invention to calculate the current-voltage characteristics, I-U.

FIG. 9 is a flowchart (flowchart 5) showing how an interpolation formula or linear extrapolation expression according to an embodiment of the invention can be used to calculate the I-U characteristics.

FIG. 10 shows the result of a calculation of the I(U) characteristics of the system illustrated in FIG. 2, with the line denoted “SCF” showing the result obtained with a full self-consistent calculation, while the line denoted “1. order” is showing the result obtained using the scheme illustrated in FIG. 8, and the line denoted “2. order” is a second order approximation.

FIG. 11 is a flowchart (flowchart 6) illustrating the use of an adaptive grid algorithm according to an embodiment of the invention for calculating the current voltage characteristics, I-U.

FIG. 12 is a flowchart (flowchart 7) being a recursive flowchart used by flowchart 6 of FIG. 11.

FIG. 13 is a flowchart (flowchart 8) being a recursive flowchart used by flowchart 6 of FIG. 11.

### DETAILED DESCRIPTION OF THE INVENTION

Background Theory

The purpose of atomic-scale modelling is to calculate the properties of molecules and materials from a description of the individual atoms in the systems. An atom consists of an ion core with charge Z, and an equal number of electrons that compensate this charge. We will use \vec{R}_{μ}, Z_{μ} for the position and charge of the ions, where μ=1 . . . N label the ions, and N is the number of ions. The positions of the electrons are given by \vec{r}ᵢ, i=1 . . . n, and n is the number of electrons.

Usually it is a good approximation to treat the ions as classical particles. The potential energy of the ions, V(\vec{R}₁, . . . , \vec{R}_{N}), depends on the energy of the electronic system, E₀, through

$$V ( {\vec{R}}_{1} , … , {\vec{R}}_{N} ) = {E}_{0} + \frac{1}{2} {\sum }_{μ , {μ}^{′} = 1}^{N} \frac{{Z}_{μ} {Z}_{{μ}^{′}} {ⅇ}^{2}}{\vert {R}_{μ} - {\vec{R}}_{{μ}^{′}} \vert} , \qquad Eq . 1$$

where e is the electron charge. The electrons must be described as quantum particles, and the calculation of the electron energy requires that we solve the many-body Schrödinger wave equation

$$\begin{matrix}\hat{H} Ψ ( {\vec{r}}_{1} , … , {\vec{r}}_{n} ) = {E}_{0} Ψ ( {\vec{r}}_{1} , … , {\vec{r}}_{n} ) , & Eq . 2 \\ \hat{H} = - {\sum }_{i = 1}^{n} \frac{{ℏ}^{2}}{2 m} {\vec{∇}}_{i}^{2} - {\sum }_{i = 1}^{n} {\sum }_{μ = 1}^{N} \frac{{Z}_{μ} {ⅇ}^{2}}{\vert {\vec{r}}_{i} - {\vec{R}}_{μ} \vert} + \frac{1}{2} {\sum }_{i , j = 1}^{n} \frac{{ⅇ}^{2}}{\vert {\vec{r}}_{i} - {\vec{r}}_{j} \vert} . & Eq . 3\end{matrix}$$

In Eq. 2, Ĥ is the many-body Hamiltonian and Ψ the many-body wavefunction of the electrons. The “hat” over the many-body Hamiltonian, Ĥ, symbolizes that the quantity is a quantum mechanical operator. The first term in Eq. 3 is the kinetic energy of the electrons, with [symbol] =h/2π where h is Planck's constant, m the electron mass and \vec{∇}ᵢ the gradient with respect to \vec{r}ᵢ. The second term is the electrostatic electron-ion attraction, and the last term is the electrostatic electron-electron repulsion.

The last term couples different electrons, and gives rise to a correlated motion between the electrons. Due to this complication an exact solution of the many-body Schrödinger equation is only possible for systems with a single electron. Thus, approximations are required that can reduce the many-body Schrödinger equation into a practical solvable model. A number of successful approaches have used an effective one-electron Hamiltonian to describe the electronic structure, and included the electron-electron interaction via an effective one-electron potential energy function in the one-electron Hamiltonian.

Density Functional Method for Electronic Structure Calculations

The invention can be used with electronic structure methods, which describe the electrons with an effective one-electron Hamiltonian. DFT and HF theory are examples of such methods. In these methods the electrons are described as non-interacting particles moving in an effective one-electron potential setup by the other electrons. The effective one-electron potential depends on the average position of the other electrons, and needs to be determined self consistently.

$${\hat{H}}_{1 el} = - \frac{{ℏ}^{2}}{2 m} {\vec{∇}}^{2} + {V}^{eff} [ n ] ( \vec{r} ) . \qquad Eq . 4$$

In Eq. 4 the term

$$term - \frac{{ℏ}^{2}}{2 m} {\vec{∇}}^{2}$$

describes the kinetic energy, V^{eff}[n](\vec{r}) the effective one-electron potential energy function and Ĥ₁ₑₗ is the one-electron Hamiltonian. The effective one-electron potential energy function depends on the electron density n. The kinetic energy is given by a simple differential operator, and therefore independent of the density. This means that the effective one-electron potential energy function and the Hamiltonian has the same variation as function of the density, and when we are interested in determining the self-consistent change of the effective one-electron potential energy function it is equivalent to specifying the self-consistent change of the Hamiltonian. Furthermore, for the self-consistent solution there is a one to one relation between the electron density and the effective one-electron potential energy function, thus specifying the self-consistent electron density, Hamiltonian or effective one-electron potential are equivalent.

In DFT the effective one-electron potential energy function is given by
V^{eff}[n]=V^{ion}+V^{xc}[n]+V^{H}[n]. Eq. 5

The first term is the ion potential energy function which is given by the electrostatic potential energy from the ion cores

$${V}^{ion} ( \vec{r} ) = {\sum }_{μ = 1}^{N} \frac{{Z}_{μ} {ⅇ}^{2}}{\vert {\vec{r}}_{i} - {\vec{R}}_{μ} \vert} , \qquad Eq . 6$$

and therefore independent of n. The second term is the exchange-correlation potential energy function
V^{xc}(\vec{r})=f(n(\vec{r}),\vec{∇}n(\vec{r}),\vec{∇}²n(\vec{r})), Eq. 7
which is a local function of the density and its gradients. The third term is the Hartree potential energy function, which is the electrostatic potential energy from the electron density and it can be calculated from the Poisson's equation
\vec{V}²V^{H}(\vec{r})=−4πen(\vec{r}). Eq. 8

Poisson's equation is a second-order differential equation and a boundary condition is required in order to fix the solution. For isolated systems the boundary condition is that the potential energy function asymptotically goes to zero, and in periodic systems the boundary condition is that the potential energy function is periodic. For such boundary conditions the solution of the Poisson's equation is straight-forward, and V^{H} can be obtained from standard numerical software packages. For systems with an external voltage U, we solve the Hartree potential in separate parts of the system. This situation is discussed in more detail on page 26.

Thus from the density, we can obtain the effective one-electron potential energy function and thereby the Hamiltonian. The next step is to calculate the electron density from the Hamiltonian. It can be obtained by summing all occupied one-electron eigenstates.

$$\begin{matrix}{\hat{H}}_{1 el} {ψ}_{α} ( \vec{r} ) = {ɛ}_{α} {ψ}_{α} ( \vec{r} ) , & Eq . 9 \\ n ( \vec{r} ) = {\sum }_{α ∈ occ} {\vert {ψ}_{α} ( \vec{r} ) \vert}^{2} . & Eq . 10\end{matrix}$$

For systems with a single chemical potential the occupied eigenstates are the states with an energy below the chemical potential. For systems with an applied external voltage U there are two chemical potentials and the situation more complicated. This situation is described on page 25.

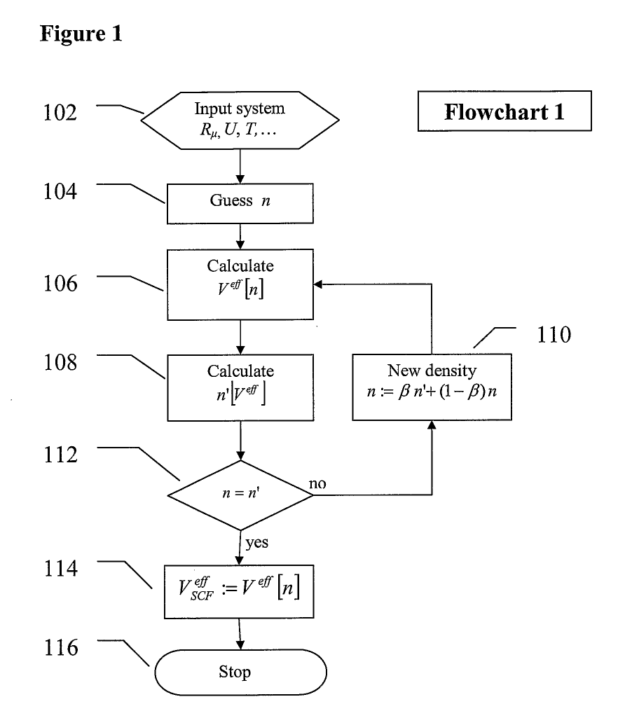

The flowchart in FIG. 1 illustrates the self-consistent loop required to solve the equations. The system is defined by the position of the atoms R_{μ} (ionic coordinates), and external parameters like applied voltage U, temperature T, and pressure P, 102. Initially we make an arbitrary guess of the electron density of the system, 104. From the density we can construct the effective one-electron potential energy function using Eq. 5, 106. The effective one-electron potential energy function defines the Hamiltonian through Eq. 4, 108. From the Hamiltonian we can calculate the electron density of the system by summing all occupied one-electron eigenstates as shown in Eq. 9, 10. If the new density is equal (within a specified numerical accuracy) to the density used to construct the effective one-electron potential energy function, 112, the self-consistent solution is obtained, 114, and we stop, 116. If the input and output electron densities are different, we make a new improved guess based on the previously calculated electron densities. In the simplest version the new guess is obtained from a linear mixing of the two electron densities, with a mixing parameters, 110.

Application of DFT to Closed and Periodic Systems

We will first show how Eq. 9 is most commonly solved for periodic and closed systems. A closed system is a system with a finite number of atoms. A periodic system is a system with an infinite number of atoms arranged in a periodic structure. For these systems, Eq. 9 is usually transformed into a matrix eigenvalue problem that can be solved with standard linear algebra packages. The transformation is obtained by writing the wave functions, ψ_{α}, as a linear combination of basis functions,

$${ψ}_{α} ( \vec{r} ) = {\sum }_{i} {a}_{i}^{α} {φ}_{i} ( \vec{r} ) .$$

Many different choices exist for the basis functions, φᵢ, some of the most common are plane-waves or atom-based functions with shapes resembling the atomic wave functions. Using the basis functions, Eq. 9 is transformed into

$$\begin{matrix}{\sum }_{j} {\overline{H}}_{ij} {a}_{j}^{α} = {ɛ}_{α} {\sum }_{j} {\overline{S}}_{ij} {a}_{j}^{α} , & Eq . 11 \\ {\overline{H}}_{ij} = 〈 {φ}_{i} \vert {H}_{1 el} \vert {φ}_{j} 〉 , & Eq . 12 \\ {\overline{S}}_{ij} = 〈 {φ}_{i} \vert {φ}_{j} 〉 , & Eq . 13 \\ n ( \vec{r} ) = {\sum }_{i , j} {\sum }_{{ɛ}_{α} < μ} {( {a}_{j}^{α} )}^{*} {a}_{i}^{α} {φ}_{i}^{*} ( \vec{r} ) {φ}_{j} ( \vec{r} ) . & Eq . 14\end{matrix}$$

The symbol H̅ denotes the Hamiltonian matrix, and S̅ the overlap matrix. The “bar” above the letters indicates that the quantities are matrixes.

For a molecular system the Hamiltonian matrix is finite and it can be diagonalized with standard linear algebra packages. For a periodic structure it is only necessary to model the part of the system, which when repeated, generates the entire structure. Thus, again the Hamiltonian matrix will be finite and the solution will be straight forward.

Application of DFT to Open Systems with an Applied Voltage

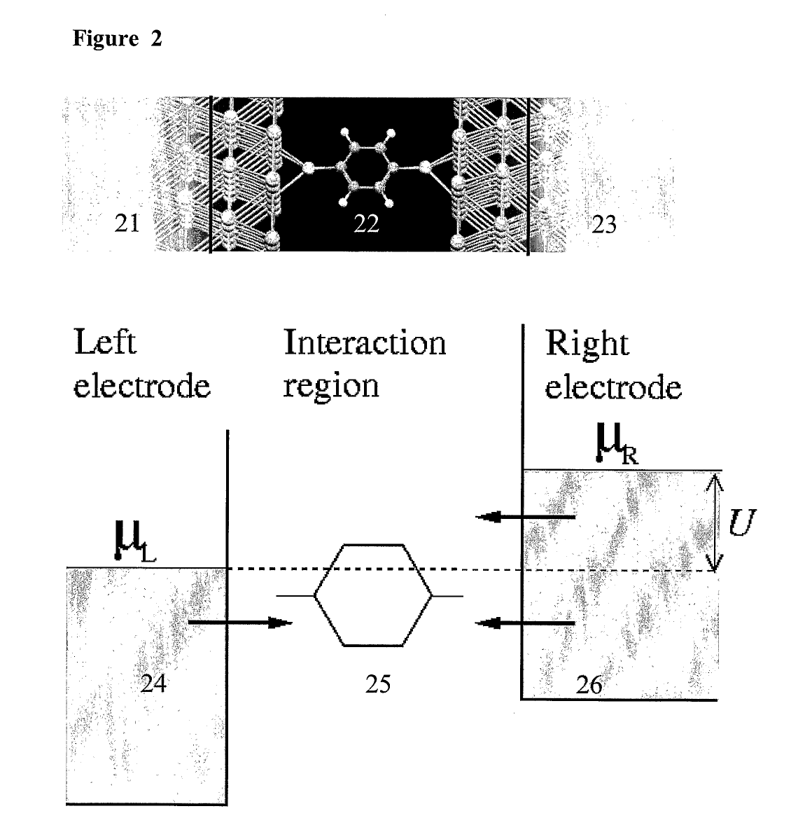

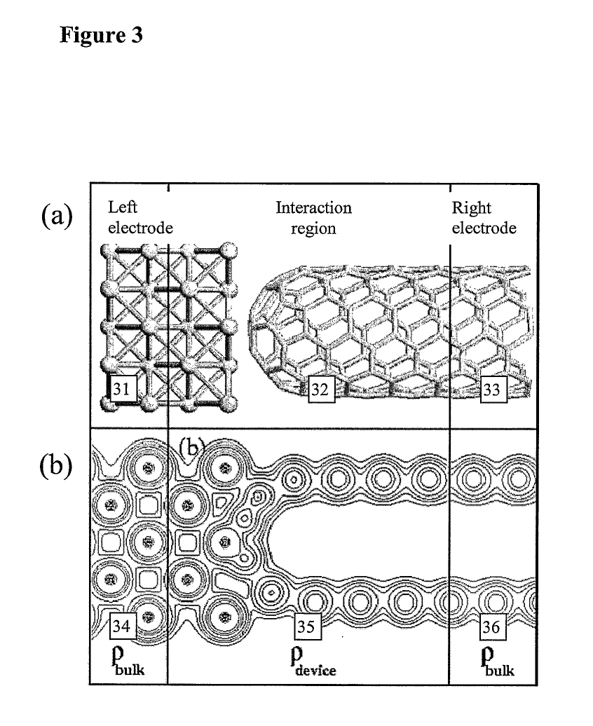

The application area of the invention is to systems where two (or more) semi-infinite electrodes are coupling with a nano-scale interaction region. We call such systems two-probe systems. The nano-scale interaction region can exchange particles with the electrodes and the two-probe systems are therefore open quantum mechanical systems. The left and right electrodes are electron reservoirs with definite chemical potentials, μ_{L} and μ_{R}. The difference between the chemical potentials,
μ_{L}−μ_{R}=eU, Eq. 15
defines the voltage bias, U, applied to the system. For open systems the Hamiltonian matrix is infinite and the simple diagonalization technique in Eq. 11 for obtaining the one-electron eigenstates cannot be applied. Instead we will determine the electron density using the non-equilibrium Green's function formalism described in the following sections. Examples of two-probe systems are illustrated in FIGS. 2 and 3. The system in FIG. 2 consists of two semi-infinite gold electrodes coupling with a Phenyl Di-Thiol molecule. The interaction region 22 consists of the molecule and the first two layers of the electrodes. Regions 21, 23 show the left and right electrode regions. Regions 24, 26 show the occupation of the one-electron levels within the electrodes; due to the applied voltage the chemical potential of the right electrode 26 is higher than for the left electrode 24.

FIG. 3 shows a semi-infinite carbon nano-tube coupling with a semi-infinite gold wire. The interaction region 32 is given by the nano-tube apex and the first layers of the gold wire. The left electrode 31 consists of a semi-infinite gold wire, and the right electrode 33 consists of a semi-infinite carbon nano-tube. The electron densities in the left electrode region 34 and in the right electrode region 36 are obtained from self-consistent bulk calculations. These densities seamlessly match the self-consistently calculated two probe density of the interaction region 35.

The Screening Approximation

The first step is to transform the open system into three subsystems that can be solved independently. FIG. 3a shows a carbon nano-tube coupled with a gold wire. The gold wire and the carbon nano-tube are metallic. Because of the metallic nature of the semi-infinite electrodes, the perturbation due to the interaction region only propagates a few Ångstrøm into the electrodes. This is illustrated in FIG. 3b, which shows the electron density. We see that when we move a few atomic distances away from the nano-tube to gold contact point, the electron density is periodic and resembles the bulk electron density. Thus, we can divide the electron density and the effective one-electron potential energy function into an interaction region and electrode regions, where the value in the electrode region is similar to the electrode bulk value. This is called the screening approximation.

Since the effective one-electron potential energy function is a local operator, the Hamiltonian operator can also be separated into electrode and interaction region. Thus, if we expand the Hamiltonian operator in a basis set with finite range, the Hamiltonian matrix can be separated into

$$\overline{H} = ( \begin{matrix}{\overline{H}}_{LL} & {\overline{H}}_{LI} & 0 \\ {\overline{H}}_{IL} & {\overline{H}}_{II} & {\overline{H}}_{IR} \\ 0 & {\overline{H}}_{RI} & {\overline{H}}_{RR}\end{matrix} ) , \qquad Eq . 16$$

where H̅_{LL}, H̅_{II}, and H̅_{RR} denotes the Hamiltonian matrix of the left electrode, interaction region, and right electrode, respectively, and H̅_{LI} and H̅_{IR} are the matrix elements involving the interaction region and the electrodes. Note that the size of the interaction region is such that there are no couplings between the left and right electrode, i.e. H_{LR}=H_{RL}=0.
Calculating the Electron Density Using Green's Functions

We will now show how the electron density is obtained within the Green's function formalism. For this purpose we introduce the spectral-density, \hat{D}(ε), and the electron density operator \hat{N}. The spectral density is the energy resolved electron density, and the total electron density is obtained by integrating the spectral density over all energies

$$\begin{matrix}\hat{D} ( ɛ ) = δ ( ɛ - \hat{H} ) , & Eq . 17 \\ \hat{N} = {\int }_{- ∞}^{μ} \hat{D} ( ɛ ) ⅆ ɛ . & Eq . 18\end{matrix}$$

In Eq. 17, the function δ(x) is Dirac's delta function. The (retarded) Green's function is defined by
Ĝ(ε)=[ε−Ĥ+iδ₊]⁻¹, Eq. 19
where δ₊ is an infinitesimal positive number and i is the complex base. The Green's function is related to the spectral density through

$$\hat{D} ( ɛ ) = \frac{1}{π} Im \hat{G} ( ɛ ) , \qquad Eq . 20$$

where Im Ĝ is the imaginary part of Ĝ. Expanding the operators in basis functions, we transform Eq. 19 into a matrix equation
G̅(ε)=[(ε+iδ₊) S̅− H̅]⁻¹, Eq. 21

From the Green's function we can obtain the spectral density matrix

$$\overline{D} ( ɛ ) = \frac{1}{π} Im \overline{G} ( ɛ ) , \qquad Eq . 22$$

and thus the electron density

$$\begin{matrix}n ( \vec{r} ) = {\sum }_{i , j} {\overline{N}}_{ij} {φ}_{i} ( \vec{r} ) {φ}_{j} ( \vec{r} ) , & Eq . 23 \\ \overline{N} = {\int }_{- ∞}^{μ} \overline{D} ( ɛ ) ⅆ ɛ . & Eq . 24\end{matrix}$$

The calculation of the electron density is now reduced to the matrix inversion in Eq. 21, and the energy integral in Eq. 24. However, we have an open system and the matrix in Eq. 21 is therefore infinite. Due to the screening approximation we only need to calculate the electron density in the interaction region since in the electrode regions we can use the bulk electron density. From Eq. 24 we see that since our basis functions are localized, we only need to calculate the Green's function matrix of the interaction region and a few layers of the electrodes.

Including the Electrode Region through a Self Energy Term

In this section we will show how the Green's function matrix of the interaction region, G̅_{II}, can be calculated by inverting a matrix with the same size. To obtain this result we will use perturbation theory in the coupling elements \tilde{H̅}_{LI}(ε)= H̅_{LI}−ε S̅_{LI} and \tilde{H̅}_{RI}(ε)= H̅_{RI}−ε S̅_{RI}. The unperturbed Green's functions, G⁰, is calculated by setting \tilde{H̅}_{LI}=\tilde{H̅}_{RI}=0 and using that in this case Eq. 21 is block diagonal
G̅_{LL}⁰(ε)=[(ε+iδ₊) S̅_{LL}− H̅_{LL}]⁻¹, Eq. 25
G̅_{II}⁰(ε)=[(ε+iδ₊) S̅_{II}− H̅_{II}]⁻¹, Eq. 26
G̅_{RR}⁰(ε)=[(ε+iδ₊) S̅_{RR}− H̅_{RR}]⁻¹. Eq. 27

Putting back the perturbation \tilde{H̅}_{LI} and \tilde{H̅}_{RI} we find the Green's function from the Dyson's equation
G̅_{II}(ε)= G̅_{II}⁰(ε)+ G̅_{II}⁰(ε)[ Σ̅_{II}^{L}(ε)+ Σ̅_{II}^{R}(ε)] G̅_{II}(ε), Eq. 28
Σ̅_{II}^{L}(ε)=\tilde{H̅}_{IL}(ε) G̅_{LL}⁰(ε)\tilde{H̅}_{LI}(ε), Eq. 29
Σ̅_{II}^{R}(ε)=\tilde{H̅}_{IR}(ε) G̅_{RR}⁰(ε)\tilde{H̅}_{RI}(ε), Eq. 30
where the terms Σ̅_{II}^{L}(ε) and Σ̅_{II}^{R}(ε) are called the selfenergies of the electrodes. Rearranging the terms in the Dyson's equation, we arrive at
G̅_{II}(ε)=[(ε+iδ₊) S̅_{II}− H̅_{II}− Σ̅_{II}^{R}(ε)]⁻¹. Eq. 31
Calculation of the Electrode Green's Function

In order to determine the self energies we need to calculate the unperturbed Green's function, G̅_{LL}⁰, of the electrodes. Since, the Hamiltonian of the electrodes is semi-infinite, the Green's function cannot be obtained by simple matrix inversion. However, in cases where the electrode Hamiltonian is periodic, there exist very efficient algorithms for calculating the electrodes Green's function. Below we will describe one of them. We will write the electrode Hamiltonian as periodic blocks, H̅_{L}_{₁}_{L}_{₁}= H̅_{L}_{₂}_{L}_{₂}= . . . , where the size of each block is such that only neighbouring blocks interact, i.e.

$${\overline{H}}_{LL} = ( \begin{matrix}⋰ & & & \\ & {\overline{H}}_{{L}_{3} {L}_{3}} & {\overline{H}}_{{L}_{3} {L}_{2}} & \\ & {\overline{H}}_{{L}_{2} {L}_{3}} & {\overline{H}}_{{L}_{2} {L}_{2}} & {\overline{H}}_{{L}_{2} {L}_{1}} \\ & & {\overline{H}}_{{L}_{1} {L}_{2}} & {\overline{H}}_{{L}_{1} {L}_{1}}\end{matrix} ) . \qquad Eq . 32$$

The Hamiltonian of each block, H̅_{L}_{₁}_{L}_{₁} and the coupling matrix, H̅_{L}_{₁}_{L}_{₂}, are obtained from a bulk calculation of the electrode system. Using recursion, we build up a series of approximations for the Green's function

$$\begin{matrix}{\overline{G}}_{{L}_{1} {L}_{1}}^{0 [ 0 ]} ( ɛ ) = {[ ( ɛ + i {δ}_{+} ) {\overline{S}}_{{L}_{1} {L}_{1}} - {\overline{H}}_{{L}_{1} {L}_{1}} ]}^{- 1} , & Eq . 33 \\ {\overline{G}}_{{L}_{1} {L}_{1}}^{0 [ 1 ]} ( ɛ ) = {[ ( ɛ + i {δ}_{+} ) {\overline{S}}_{{L}_{1} {L}_{1}} - {\overline{H}}_{{L}_{1} {L}_{1}} - {\overline{H}}_{{L}_{1} {L}_{2}} {\overline{G}}_{{L}_{2} {L}_{2}}^{0 [ 0 ]} {\overline{H}}_{{L}_{2} {L}_{1}} ]}^{- 1} , & Eq . 34 \\ {\overline{G}}_{{L}_{1} {L}_{1}}^{0 [ 2 ]} ( ɛ ) = {[ ( ɛ + i {δ}_{+} ) {\overline{S}}_{{L}_{1} {L}_{1}} - {\overline{H}}_{{L}_{1} {L}_{1}} - {\overline{H}}_{{L}_{1} {L}_{2}} {\overline{G}}_{{L}_{2} {L}_{2}}^{0 [ 1 ]} {\overline{H}}_{{L}_{2} {L}_{1}} ]}^{- 1} , & Eq . 35 \\ ⋮ & Eq . 36\end{matrix}$$

In Eq. 33, 34, 35 the quantity G̅_{L}_{₁}_{L}_{₂}^{0[n]}(ε) is the n'order approximation to the Green's function. The error, [ G̅_{L}_{₁}_{L}_{₁}⁰(ε)− G̅_{L}_{₁}_{L}_{₁}^{0[n]}(ε)] decreases as 1/n where n is the number of steps. Due to this poor convergence usually more than 1000 steps are required to obtain reasonable accuracy with this algorithm. The Green's function can be obtained in fewer steps by using a variant of the method described in Lopez-Sancho, J. Phys. F 14, 1205 (1984). With this variant of the algorithm only a few steps are needed to calculate the electrode Green's function, and the computational resources required for this part is usually negligible compared to the resources required for the calculation of G̅_{II}.

Integration of the Spectral Density Using a Complex Contour

We now have all the ingredients required in Eq. 31 to obtain G̅_{II} and thereby the electron density matrix,

$${\overline{N}}_{ij} = \frac{1}{π} {\int }_{- ∞}^{μ} Im {\overline{G}}_{ij} ( ɛ ) ⅆ ɛ . \qquad Eq . 37$$

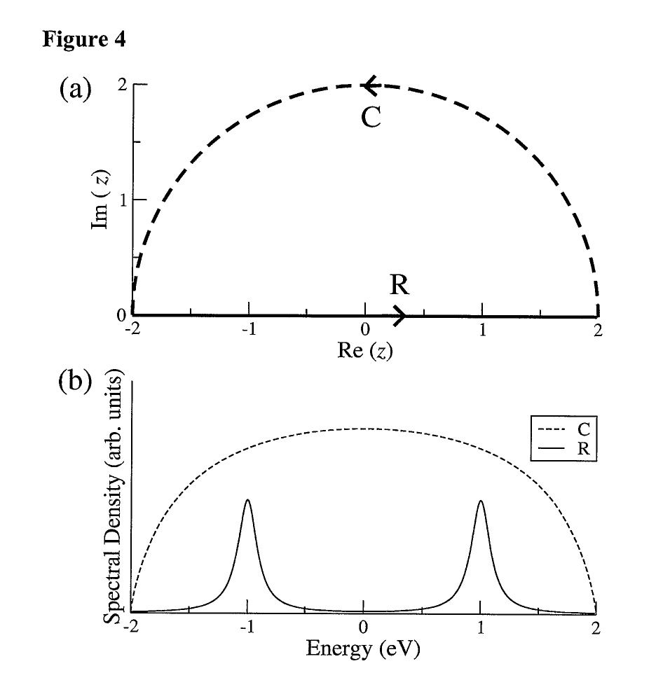

The Green's function is a rapidly varying function along the real axis, and for realistic systems often an accurate determination of the integral requires more than 5000 energy points along the real axis. To find a more efficient method we use that the Green's function is an analytical function, and we can do the integral along a contour in the complex plane. In the complex plane the Green's function is very smooth. This is illustrated in FIG. 4. In FIG. 4a we show two equivalent lines of integrations, the contour C and the real axis line R. FIG. 4b shows the variation of the spectral density along C (dashed) and along R (solid). The function varies much more rapidly along R, and substantially more points are needed along R than along C to obtain the same accuracy. Typically, the use of contour integration reduces the number of integration points by a factor 100.

The Electron Density for a Two Probe System with External Voltage Bias

We have so far used that the system has a single chemical potential, i.e. μ_{L}=μ_{R}. However, if we apply an external voltage, U, the two electrodes will have different chemical potentials linked through Eq. 15. FIG. 2 illustrates the system set up. The energy axis can be divided into two regions, the energy range below both chemical potentials we call the equilibrium region, and the energy range between the two chemical potentials we call the non-equilibrium region or voltage window. We will divide the electron density matrix into two parts,
N̅ᵢⱼ= N̅ᵢⱼ^{eq}+ N̅ᵢⱼ^{neq}, Eq. 38
where N̅ᵢⱼ^{eq} is the electron density matrix of the electrons with energies in the equilibrium region, and N̅ᵢⱼ^{neq} the electron density matrix of the electrons with energies in the non-equilibrium region. We may say that N̅ᵢⱼ^{neq} is the additional density due to the external voltage U.

N̅ᵢⱼ^{eq} can be calculated with the approach described in the previous sections, thus

$${\overline{N}}_{ij}^{eq} = \frac{1}{π} {\int }_{- ∞}^{{μ}_{L}} Im {\overline{G}}_{ij} ( ɛ ) ⅆ ɛ , \qquad Eq . 39$$

where we have assumed that μ_{L}<μ_{R}.

In the non-equilibrium region electrons are only injected from the right reservoir. Thus we need to divide the spectral density matrix into electron states originating from the left or right electrode, and only add the right electrode electron density. This division of the electron density is accomplished in non-equilibrium Green's function theory, and we may write

$${\overline{N}}_{II}^{neg} = \frac{1}{π} {\int }_{{μ}_{L}}^{{μ}_{R}} {\overline{G}}_{II} ( ɛ ) Im {\sum }_{II}^{R} ( ɛ ) {\overline{G}}_{II}^{†} ( ɛ ) ⅆ ɛ . \qquad Eq . 40$$

The foundation of this equation can be found in Haug and A. P. Jauho, Quantum kinetics in transport and optics of semiconductors, (Springer-Verlag, Berlin, 1996) or Brandbyge Phys. Rev. B 65, 165401 (2002). Thus, we now have a description for how to calculate the electron density of the two probe system, including the situation with an external voltage applied to the system.

Calculating the Effective One-Electron Potential Energy Function in a Two-Probe System

In the previous sections we showed how to calculate the electron density from the Hamiltonian using the Green's function approach. To complete the self-consistent cycle we need to calculate the Hamiltonian from the electron density, which means calculating the effective one-electron potential energy function, V^{eff}[n]. Within DFT the effective one-electron potential energy function is given by Eq. 5. For the two-probe system we need to solve Poisson's equation, Eq. 8, for the interaction region and the electrode regions separately. The Hartree potential energy function of the electrodes is obtained with the same approach as used for periodic systems, in this case the repeated structure is the electrode cell used to defined H_{L}_{₁}_{L}_{₁} in Eq. 32 and the corresponding cell for the right electrode H_{R}_{₁}_{R}_{₁}. These electrode Hartree potential energy functions now supply boundary conditions for the Hartree potential energy function of the interaction region. However, the electrodes are bulk systems and this means that we can add an arbitrary constant to their Hartree potential energy function and still obtain a valid solution. To fix this arbitrary constant we relate each electrode Hartree potential energy function to the chemical potential of the electrode, and use Eq. 15 to relate the left and right chemical potential. Thus, we now have fixed the Hartree potentials in the electrodes and they define the boundary condition of the Poisson's equation in the central region along the z direction. In the x and y direction we will use periodic boundary conditions. With these boundary conditions the Hartree potential energy function of the interaction region can be obtained by a multigrid approach, as described in Taylor, Phys. Rev. B 63, 245407 (2001).

Electron Transport Coefficients and Currents Obtained from the Green's Function

After finishing the self-consistent cycle we can calculate the transport properties of the system. The non-linear current through the contact, I, is obtained as

$$I ( U ) = {G}_{0} {\int }_{{μ}_{L}}^{{μ}_{L} + U} Tr [ Im {\sum }_{II}^{L} ( ɛ ) {\overline{G}}_{II} ( ɛ ) Im {\sum }_{II}^{R} ( ɛ ) {\overline{G}}_{II}^{†} ( ɛ ) ] , \qquad Eq . 41$$

where

$${G}_{0} = 2 \frac{{ⅇ}^{2}}{h}$$

is the conduction quantum. The foundation of this equation is described in H. Haug, Quantum kinetics in transport and optics of semiconductors, (Springer-Verlag, Berlin, 1996).
The Self-Consistent Algorithm for the Two-Probe System

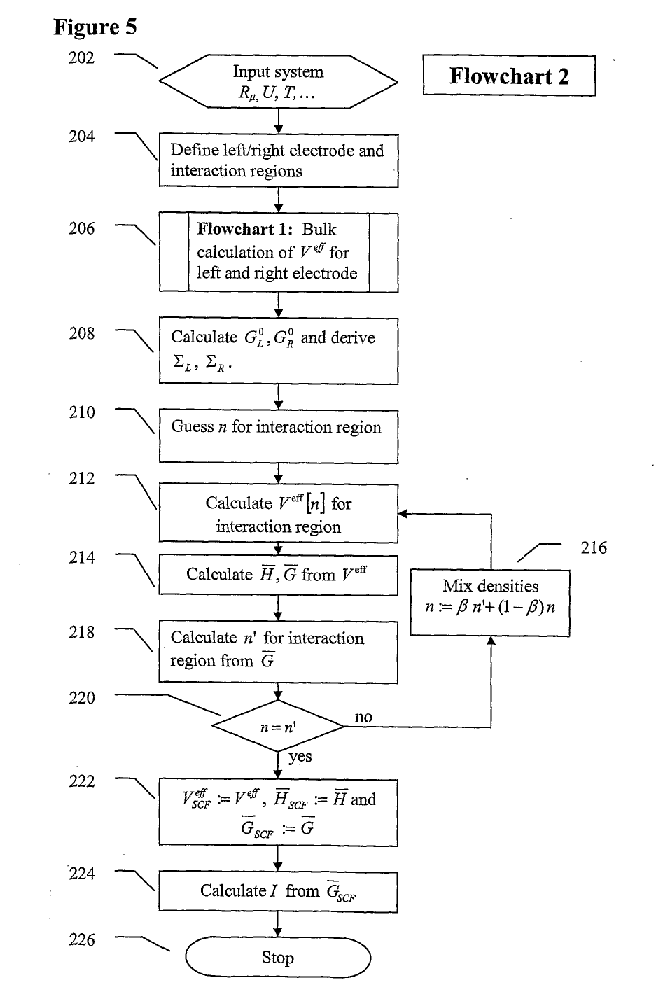

FIG. 5 shows required steps for a two-probe calculation of the electrical current from the left to the right electrode through a nano-scale device due to an applied voltage between the left and right electrode as described in Eq. 15. Initially we define the system by specifying the ionic positions, and the external parameters like the applied voltage and temperature, 202. Next we use the screening approximation to separate the system geometry into interaction and electrode regions, 204. The electron density and the effective one-electron potential energy function should approach their bulk value in the electrode region. Usually this will be the case around atoms in the third layer of a metallic surface, and it is therefore sufficient to include the first two layers of metallic surfaces within the interaction region. We calculate the self-consistent effective one-electron potential energy function for the isolated electrode regions using the flowchart in FIG. 1, 206. From the self-consistent effective one-electron potential energy function we construct the electrode Greens functions, using Eq. 4, 12, 33-36, and the electrode selfenergies using Eq. 29, 30, 208. These initial calculations are now used as input to the two-probe calculation. Thus, we have calculated the self-consistent density of the electrode regions and only need to calculate the self-consistent density of the interaction region. Starting with an initial guess of the electron density for the interaction region, 210, we perform a self-consistent loop similar to the flowchart in FIG. 1. First we calculate the effective one-electron potential energy function of the interaction region using Eq. 5-8, 212. From the effective one-electron potential energy function we can obtain the Hamiltonian using Eq. 4, 12 and the Green's function through Eq. 31, 214. From the Green's function we can calculate the electron density using Eq. 23, 38, 39, 40, and thereby close the self-consistent cycle, 218. If the new electron density is different (within a specified numerical accuracy) from the electron density used to construct the effective one-electron potential energy function, 220, we make a new improved guess based on the previously calculated densities. In the simplest version the new guess is obtained from a linear mixing of the two densities, with a mixing parameter β, 216. If the input and output densities are equal, we have obtained the self-consistent value of the electron density and thereby also the effective one-electron potential energy function, Hamiltonian and Green's function, 222. From this Green's function we can calculate the current using Eq. 41, 224. After the calculation of the current the algorithm stops, 226.

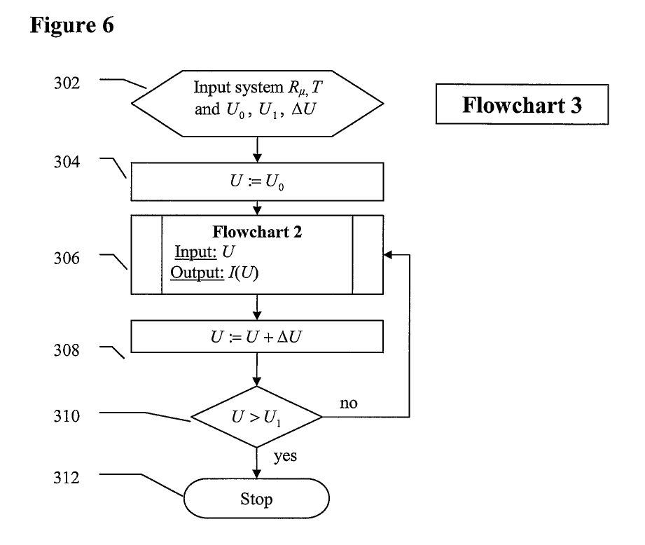

The procedure has been implemented in the TranSIESTA and McDCAL software. Further description of these softwares and the implementation details can be found in Brandbyge Phys. Rev. B 65, 165401 (2002), and Taylor Phys. Rev. B 63, 245407 (2001). To obtain the current-voltage characteristics, I-U curve, of a nano-scale device, we need to perform a self-consistent calculation for each voltage U. This is illustrated in the flowchart of FIG. 6. Input system geometry and the voltage interval U₀, U₁ and step size ΔU, 302. Set starting voltage to U₀, 304. Follow the steps in flowchart 2 of FIG. 5 to perform a self-consistent calculation of the effective one-electron potential energy function at voltage U, and use the self-consistent potential energy function to calculate the current, 306. Increase the voltage with the step size, 308, if the new voltage is within the specified voltage interval, then perform a new self-consistent calculation, 310, else stop, 312.

Example: Calculation of the I-U Characteristics of DTP Coupled with Gold Surfaces

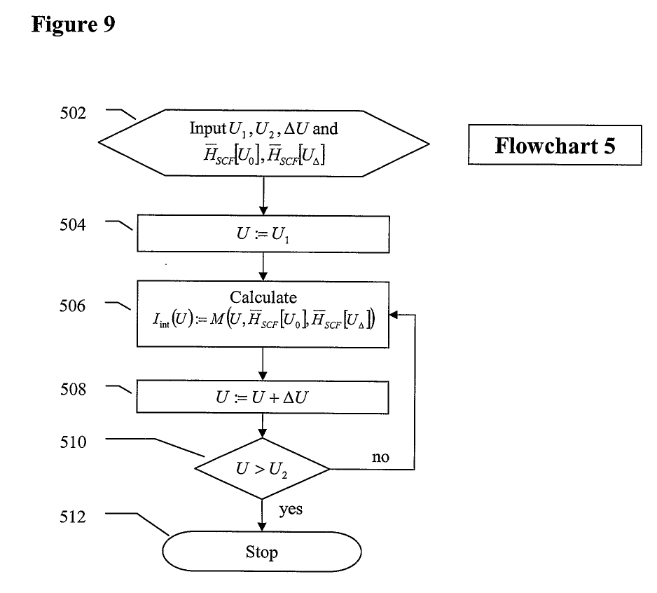

We will now present results for the calculation of the I-U characteristics of the geometry illustrated in FIG. 2 using the TranSIESTA software. The calculation follows flowchart 3 of FIG. 6, and the points in FIG. 9 show the result of the calculation. A similar I-U characteristic was obtained in Stokbro Computational Materials Science 27, 151 (2003).

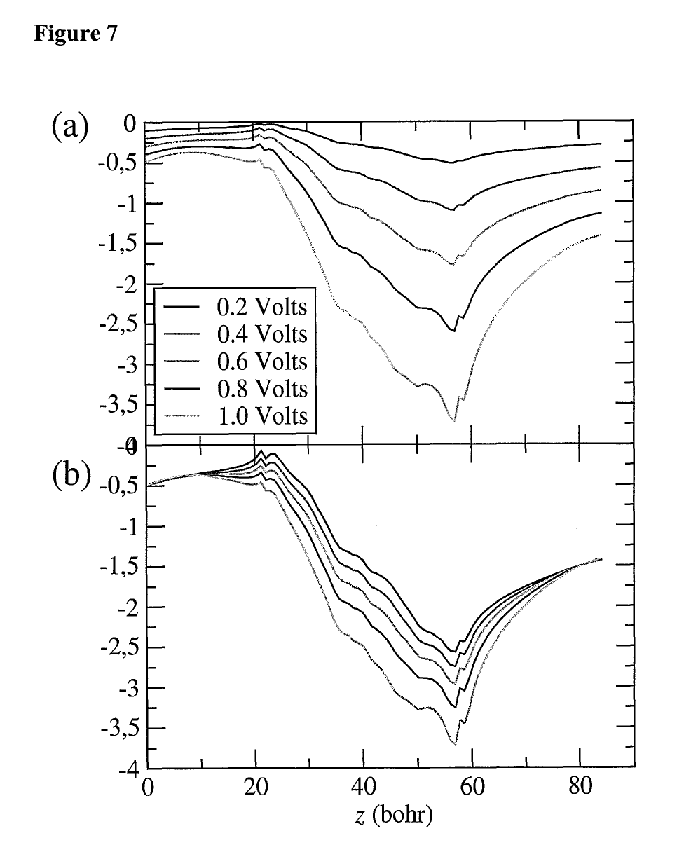

In FIG. 7 we show the change in the self-consistent effective one-electron potential energy function due to the applied voltage. The value of the effective one-electron potential energy function is shown along a line starting in the left electrode, going through the center of the two sulphur atoms of the DTB molecule and ending in the right electrode. In the right electrode the effective one-electron potential energy function is shifted down due to the applied voltage. The main feature is that the effective one-electron potential energy function is flat in the electrode regions, and the main voltage drop is taken place within the molecular region.

The curves in FIG. 7a all have similar shapes. In FIG. 7b we have rescaled the curves with the applied voltage, and we observe that the rescaled effective one-electron potential energy functions are nearly identical. This observation forms a basis for the invention as it shows that the self-consistent change in the effective one-electron potential energy function has a simple variation with the applied voltage.

Linear Interpolation Using Two Voltage Points

In one version of the algorithm, the effective one-electron potential energy function is calculated at zero voltage, U₀ and for a small finite voltage, U_{Δ}. These data are now used to extrapolate to a general voltage. The effective one-electron potential energy function for the general voltage, U, is obtained by simple linear extrapolation

$${V}_{int}^{eff} [ U ] := {V}_{SCF}^{eff} [ {U}_{0} ] + \frac{U + {U}_{0}}{{U}_{Δ} - {U}_{0}} ( {V}_{SCF}^{eff} [ {U}_{Δ} ] - {V}_{SCF}^{eff} [ {U}_{0} ] ) . \qquad Eq . 42$$

The Hamiltonian is related to the effective one-electron potential energy function by

$$\hat{H} = - \frac{ℏ}{2 m} {\hat{∇}}^{2} + {V}^{eff} . \qquad Eq . 43$$

This means that the same scaling relation applies to the Hamiltonian. Thus, the Hamiltonian at a general voltage can be approximated by

$${\hat{H}}_{int} [ U ] := {\hat{H}}_{SCF} [ {U}_{0} ] + \frac{U - {U}_{0}}{{U}_{Δ} - {U}_{0}} ( {\hat{H}}_{SCF} [ {U}_{Δ} ] - {\hat{H}}_{SCF} [ {U}_{0} ] ) , \qquad Eq . 44$$

where Ĥ_{SCF}[U₀] and Ĥ_{SCF}[U_{Δ}] are the self-consistent Hamiltonian at U₀ and U_{Δ}.

In most electronic structure methods the Hamiltonian is expanded in a basis set {φᵢ}, and represented by the matrix
H̅ᵢⱼ= [symbol] φᵢ|Ĥ|φⱼ [symbol] . Eq. 45

In this case the linear interpolation formula is applied to the Hamiltonian matrix elements.

From the Hamiltonian we can calculate all properties of the system, including the electrical current due to the applied voltage. The electrical current is obtained by first calculating the Green's function using Eq. 31 and from the Green's function calculate the current using Eq. 41. We may combine Eq. 44, 31 and 41 and write it as a mapping, M, that takes H̅_{SCF}[U₀], H̅_{SCF}[U_{Δ}], U, and returns the current, I, at voltage U. We write the mapping as
I(U):=M(U, H̅_{SCF}[U₀], H̅_{SCF}[U_{Δ}]), Eq. 46

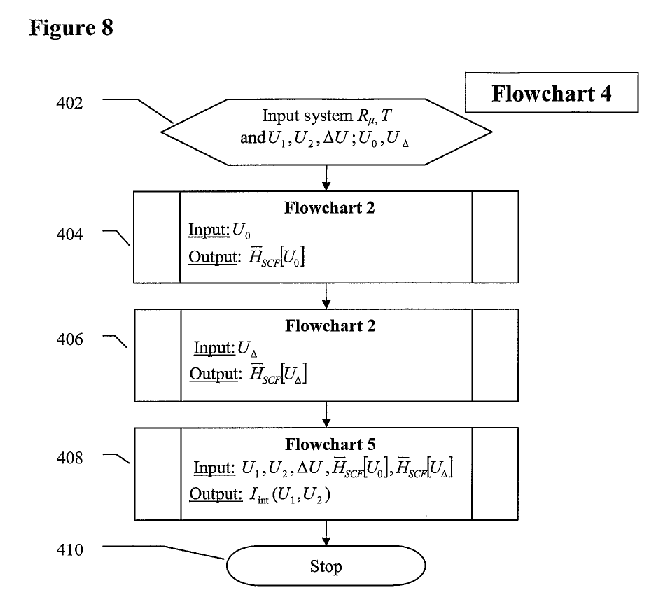

The calculation of the I-U characteristics using the interpolation formula is summarized by flowchart 4 in FIG. 8. Input system geometry and the voltage interval U₁, U₂, step size ΔU, and voltages U₀U_{Δ} where we will calculate the self-consistent Hamiltonians that are used for the interpolation, 402. Use flowchart 2 of FIG. 5 to calculate the self-consistent effective one-electron potential energy function and Hamiltonian for voltage U₀, 404. Self-consistent calculation for voltage U_{Δ}, 406. Use flowchart 5 of FIG. 9 to calculate the I-U curve for the voltage interval U₁,U₂ using Eq. 46 with the self-consistent results at U₀ and U_{Δ} to obtain an approximation for the current, 408. Stop, 410. The calculation of the I-U curve follows flowchart 5 of FIG. 9. Input voltage interval U₁, U₂, step size ΔU and the self-consistent Hamiltonian for two voltages, U₀ and U, 502. Set starting voltage to U:=U₁, 504. Use Eq. 46 with the self-consistent results at U₀ and U_{Δ} to obtain an approximation for the current at U, 506. Increase the voltage with the step size, 508, if the new voltage is within the specified voltage interval, then continue calculating the I-U curve, 510, else stop, 512.

Typical parameters for the calculation will be to select U₀=0 Volt and U_{Δ}=0.4 Volt. It is most computationally efficient to choose a relative low value of the voltage, since the self-consistent calculation is more computationally demanding at a high voltage due to the calculation of the non-equilibrium density, Eq. 40, which involves an integral where the number of points is proportional to the size of the voltage.

Typical values for the range of the voltage in the I-U curve will be U₁=−2.0 Volt and U₂=2.0 Volt. At higher voltages the electric field will be very high for a small nano-scale device, and such voltages are difficult to measure experimentally due to electrical breakdown of the device.

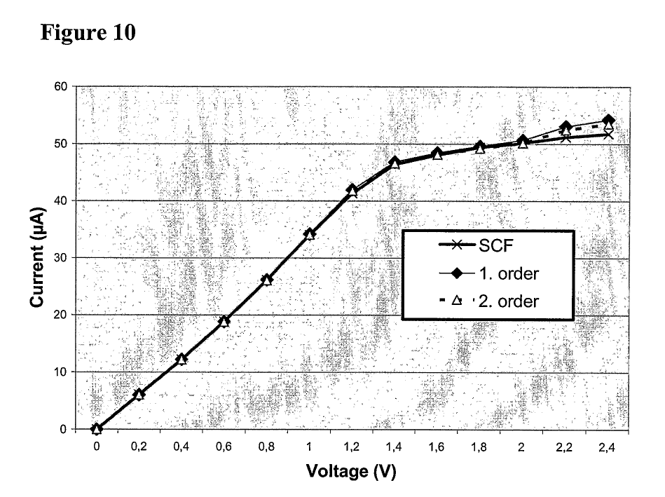

In FIG. 10 we compare the result of calculating the current using the formula in Eq. 46 with the full self-consistent solution. The line denoted “1. order” shows the result obtained with Eq. 46, while the line denoted “SCF” shows the result obtained with the self-consistent calculation. We see that the results obtained with Eq. 46 are in excellent agreement with the full self-consistent calculation for V<2.0 Volt, even though only calculations at V=0.0 Volt and V=0.4 Volt were used for the calculation.

Adaptive Grid Method for Calculating the I-U Characteristics.

In the previous section we used a two point interpolation formula to extrapolate the Hamiltonian to a general voltage using the self-consistent Hamiltonian at two voltages U₀ and U_{Δ}. We will now propose a systematic method to improve this scheme. The method is based on performing additional self-consistent calculations at selected voltage points, and using the self-consistent Hamiltonian at these voltage points to make improved interpolation formulas. With this method a series of I-U curves are produced that converges towards the self-consistently calculated I-U characteristics.

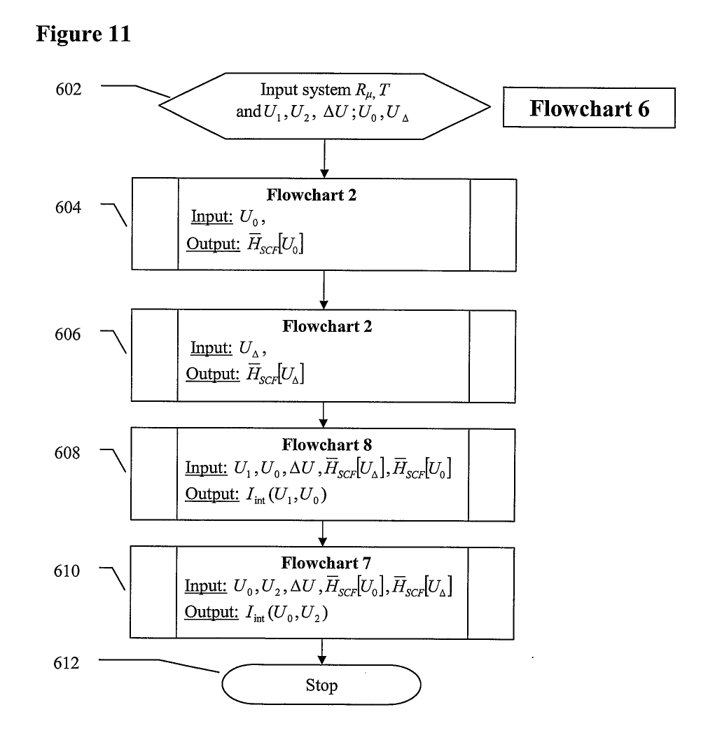

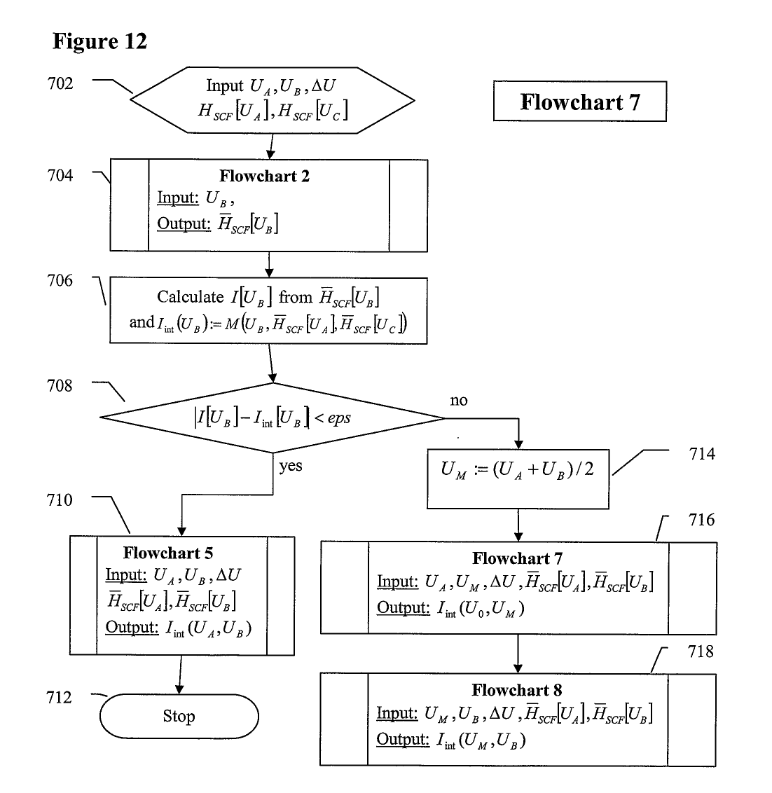

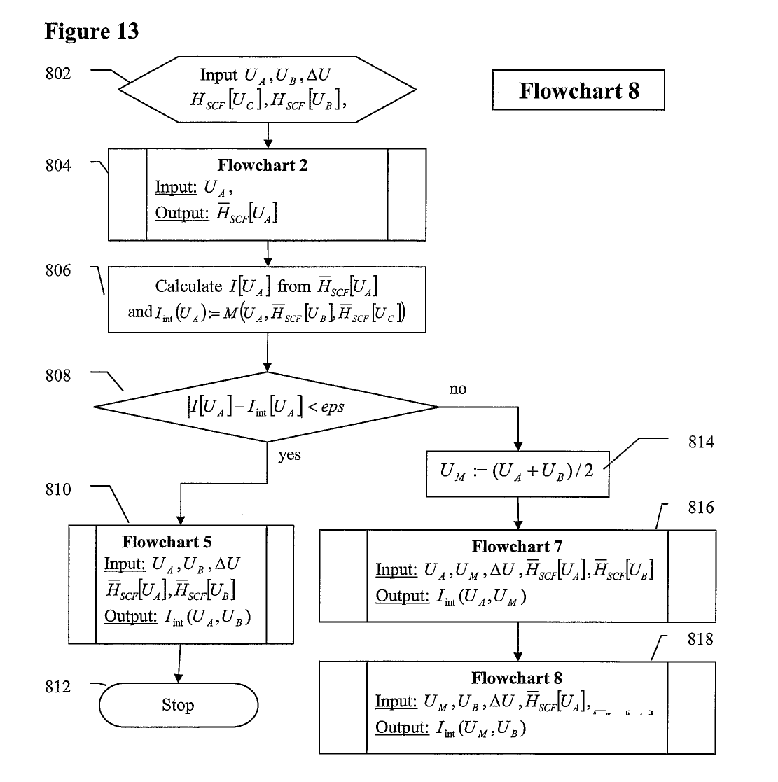

The target is to calculate the I-U characteristics in the interval [U₁,U₂]. Flowchart 6 in FIG. 11 shows the steps involved in the calculation. The initial steps are similar to flowchart 4 of FIG. 8; however, in this new algorithm we will improve the approximation by performing additional self-consistent calculations, where the new voltage points may be selected by the algorithm shown in flowcharts 7 and 8 of FIGS. 12 and 13. Input system geometry and the voltage interval U₁, U₂, step size ΔU, and interpolation voltages U₀,U_{Δ}, 602.

Use flowchart 2 of FIG. 5 to calculate the self-consistent effective one-electron potential energy function and Hamiltonian for voltage U₀, 604. Self-consistent calculation for voltage U_{Δ}, 606. Use flowchart 8 of FIG. 13 to calculate the I-U curve for the voltage interval U₁,U₀ using Eq. 46 with the self-consistent results at U₀ and U_{Δ} to obtain an approximation for the current, 608. Use flowchart 7 of FIG. 12 to calculate the I-U curve for the voltage interval U₀,U₂ using Eq. 46 with the self-consistent results at U₀ and U_{Δ} to obtain an approximation for the current, 610. Stop 612.

Flowcharts 7 and 8 of FIGS. 12 and 13 show the algorithms for subdivision of the interval. The interval is subdivided until interpolated and self-consistent calculated currents agree within a specified accuracy, which we denote δ. Flowchart 7 and 8 are similar except that flowchart 7 assumes the self-consistent Hamiltonian is known for the lowest voltage U_{A} of the voltage interval where we request the I-U curve, while flowchart 8 assumes the self-consistent Hamiltonian is known for the highest voltage U_{B} of the voltage interval. For flowchart 7, the input to the recursion step is the voltage interval U_{A}, U_{B}, and the self-consistent Hamiltonian at the endpoint U_{A} and at an arbitrary voltage point U_{C}, 702. Next we perform a self-consistent calculation at the highest voltage U_{B} of the voltage interval, 704. We calculate the current from the interpolation formula, Eq. 46 and from the self-consistent Hamiltonian Eq. 31, 41, 706. If the interpolated current differs by more than δ from the self-consistent current, 708, we will further subdivide into intervals {U_{A},U_{M}} and {U_{M},U_{B}}, where U_{M}:=(U_{A}+U_{B})/2, 714. The algorithm is recursively called with the interval {U_{A},U_{M}}, 716. For the interval {U_{M},U_{B}} we know the Hamiltonian at the last voltage point instead of for the first voltage point, and we use the slightly modified algorithm shown in flowchart 8, 718. The procedure is continued until the self-consistently calculated current for the new grid point agrees with the interpolated value within the prescribed accuracy δ. When the prescribed accuracy is obtained we can safely use Eq. 46 to calculate the I-U characteristics of the subinterval {U_{A},U_{B}}, 710. The recursive algorithm stops, 712.

The algorithm in flowchart 8 of FIG. 13 is a slight modification of the algorithm in flowchart 7 of FIG. 12, the only difference being that the input self-consistent Hamiltonian is calculated at U_{B} instead of U_{A}. Here we just mention the differences in flowchart 8 when compared to flowchart 7. Input H_{SCF}[U_{B}] instead of H_{SCF}[U_{A}], 802. Perform self-consistent calculation at U_{A} instead of at U_{B}, 804. Calculate the current at U_{A}, 806, compare currents calculated at U_{A}, 808. The remainder of the algorithm is similar to the algorithm flowchart 7.

We note that in general this procedure will result in grid points unevenly distributed over the voltage window. The grid points will be most dense in the regions where the linear interpolation formula gives a poor description of the variation of the self-consistent potential energy function. Thus the algorithm results in an adaptive formation of the grid points.

Using Higher Order Approximations

For the methods described in the previous section the approximate solution was systematically improved by performing additional self-consistent calculations. When more than two self-consistent calculations are performed it is possible to use higher order interpolation formulas. For instance, self-consistent calculations at U₀, U₁, and U₂, can be combined to obtain a second order extrapolation formula

$$\begin{matrix}{V}_{int}^{eff} [ U ] := {V}_{SCF}^{eff} [ {U}_{0} ] + ( U - {U}_{0} ) b + {( U - {U}_{0} )}^{2} c & Eq . 46 b \\ c = ( {V}_{SCF}^{eff} [ {U}_{1} ] - \frac{{U}_{1} - {U}_{0}}{{U}_{2} - {U}_{0}} {V}_{SCF}^{eff} [ {U}_{2} ] ) / ( {U}_{2} {U}_{2} - {U}_{1} {U}_{1} ) & Eq . 46 c \\ b = {V}_{SCF}^{eff} [ {U}_{1} ] / ( {U}_{1} - {U}_{0} ) - c ( {U}_{1} - {U}_{0} ) & Eq . 46 d\end{matrix}$$

for the effective potential, Vᵢₙₜ^{eff}[U]. Similar second order extrapolation formulas can be used for the Hamiltonian,

$$\begin{matrix}H [ U ] := H [ {U}_{0} ] + ( U - {U}_{0} ) b + {( U - {U}_{0} )}^{2} c & Eq . 46 e \\ c = ( H [ {U}_{1} ] - \frac{{U}_{1} - {U}_{0}}{{U}_{2} - {U}_{0}} H [ {U}_{2} ] ) / ( {U}_{2} {U}_{2} - {U}_{1} {U}_{1} ) & Eq . 46 f \\ b = H [ {U}_{1} ] / ( {U}_{1} - {U}_{0} ) - c ( {U}_{1} - {U}_{0} ) & Eq . 46 g\end{matrix}$$

The line denoted “2. order” in FIG. 10 shows the result using a second order extrapolation formula obtained from self consistent calculations at 0.0 Volts, 0.4 Volts and 1.0 volts. The above can easily be generalized such that for n biases a (n−1) order extrapolation formula is used.

Generalization to Multi-Probe Systems

The algorithm can be generalized to multi-probe systems, i.e. systems where there are more than two electrodes. Lets assume that we will include one additional electrode, then we can relate the chemical potential of this electrode, μ₃, to the chemical potential of the left electrode through the applied voltage between the electrodes, U^{L3}
μ_{L}−μ₃=e_{U}^{L3}. Eq. 47

We can now generalize Eq. 44 to a two-dimensional interpolation formula in the variables U^{L3} and U^{LR}, where the latter is the voltage difference between the left and the right electrode. It is convenient to choose U₀^{L3}=U₀^{LR}=U₀=0, since then we can use the same self-consistent Hamiltonian for the U₀ value in the interpolation formula. In this case

$${\hat{H}}_{int} [ {U}^{L 3} , {U}^{LR} ] := {\hat{H}}_{SCF} [ {U}_{0} ] + \frac{{U}^{L 3} - {U}_{0}}{{U}_{Δ}^{L 3} - {U}_{0}} ( {\hat{H}}_{SCF} [ {U}_{Δ}^{L 3} ] - {\hat{H}}_{SCF} [ {U}_{0} ] ) + \frac{{U}^{LR} - {U}_{0}}{{U}_{Δ}^{LR} - {U}_{0}} ( {\hat{H}}_{SCF} [ {U}_{Δ}^{LR} ] - {\hat{H}}_{SCF} [ {U}_{0} ] ) \qquad Eq . 48$$

where U_{Δ}^{L3}, U_{Δ}^{LR} are a small voltage increase in the left electrode-electrode 3 and left electrode-right electrode voltages, respectively. The self-consistent Hamiltonians Ĥ_{SCF}[U_{Δ}^{L3}] are calculated for U^{L3}=U_{Δ}^{L3}, U^{LR}=0, and Ĥ_{SCF}[U_{Δ}^{LR}] are calculated for U^{LR}=U_{Δ}^{LR},U^{L3}=0.
Generalization to Use Electronic or Ionic Temperature

So far we have implicitly assumed that the electronic temperature is zero, since all integrals are written with fixed integration boundaries at the chemical potentials. To include a finite electronic temperature we must change the integrals in Eq. 18, 24, 37, 39, 40, 41 such that

$${\int }_{}^{μ} \to {\int }_{}^{∞} f [ ( ɛ - μ ) / kT ] , \qquad Eq . 49$$

where T is the temperature, k the Boltzmanns constant, and f is the Fermi function

$$f [ x ] = \frac{1}{{ⅇ}^{x} + 1} . \qquad Eq . 50$$

We can readily generalize this to use different electronic temperatures for the left and right electrode, by using different values of T in the Fermi function for the left and right electrode.

Those skilled in the art will appreciate that the invention is not limited by what has been particularly shown and described herein as numerous modifications and variations may be made to the preferred embodiment without departing from the spirit and scope of the invention.

1-56. (canceled)

57. Method of using extrapolation analysis to express an approximate self-consistent solution or a change in a self-consistent solution based on a change in the value of one or more external parameters, said self-consistent solution being used in a model of a system having at least two probes or electrodes, which model is based on an electronic structure calculation comprising a self-consistent determination of an effective one-electron potential energy function and/or an effective one-electron Hamiltonian, the method comprising:
determining a first self-consistent solution to a selected function for a first value of a first external parameter by use of self-consistent loop calculation,
determining a second self-consistent solution to the selected function for a second value of the first selected external parameter by use of self-consistent loop calculation, said second value of the first selected external parameter being different to the first value of the first selected external parameter, and
expressing an approximate self-consistent solution or a change in the self-consistent solution for the selected function for at least one selected value of the first selected external parameter by use of extrapolation based on at least the determined first and second self-consistent solutions and the first and second values of the first selected external parameter.

58. A method according to claim 57, wherein the approximate self-consistent solution or change in the self-consistent solution is expressed by use of linear extrapolation.

59. A method according to claim 57, wherein
a third self-consistent solution to the selected function is determined for a third value of the first selected external parameter by use of self-consistent loop calculation, said third value of the first selected external parameter being different to the first and second values of the first selected external parameter, and wherein
the approximate self-consistent solution or change in the self-consistent solution for the selected function for at least one selected value of the first selected external parameter is expressed by use of extrapolation based on at least the determined first, second and third self-consistent solutions and the first, second and third values of the first selected external parameter.

60. A method according to claim 59, wherein the approximate self-consistent solution or change in the self-consistent solution is expressed by use of second order extrapolation.

61. A method according to claim 57, wherein the system being modelled is a nano-scale device or a system comprising a nano-scale device.

62. A method according to claim 57, wherein the modelling of the system comprises providing one or more of the external parameters as inputs to said probes or electrodes.

63. A method according to claim 57, wherein the system is a two-probe system and the external parameter is a voltage bias, U, across said two probes or electrodes, said two-probe system being modelled as having two substantially semi-infinite probes or electrodes being coupled to each other via an interaction region.

64. A method according to claim 57, wherein the system is a three-probe system with three probes or electrodes and the external parameters are a first selected parameter and a second selected parameter being of the same type as the first selected parameter.

65. A method according to claim 64, wherein the system is a three-probe system with three probes or electrodes and the external parameters are a first voltage bias, U1, across a first and a second of said electrodes and a second voltage bias, U2, across a third and the first of said electrodes, said three-probe system being modelled as having three substantially semi-infinite electrodes being coupled to each other via an interaction region.

66. A method according to claim 64, said method further comprising:
determining a fourth self-consistent solution to the selected function for a first value of the second selected external parameter by use of self-consistent loop calculation,
determining a fifth self-consistent solution to the selected function for a second value of the second selected external parameter by use of self-consistent loop calculation, said second value of the second selected external parameter being different to the first value of the second selected external parameter, and wherein said expressing of the approximate self-consistent solution or change in the self-consistent solution for the selected function is expressed for the selected value of the first selected external parameter and a selected value of the second selected external parameter by use of extrapolation based on at least the determined first and second self-consistent solutions together with the first and second values of the first selected external parameter, and further based on at least the determined fourth and fifth self-consistent solutions together with the first and second values of the second selected external parameter.

67. A method according to claim 66, wherein the approximate self-consistent solution or change in the self-consistent solution is expressed by use of linear extrapolation.

68. A method according to claim 59, wherein the system is a three-probe system with three probes or electrodes and the external parameters are a first selected parameter and a second selected parameter being of the same type as the first selected parameter.

69. A method according to claim 68, said method further comprising:
determining a fourth self-consistent solution to the selected function for a first value of the second selected external parameter by use of self-consistent loop calculation,
determining a fifth self-consistent solution to the selected function for a second value of the second selected external parameter by use of self-consistent loop calculation, said second value of the second selected external parameter being different to the first value of the second selected external parameter, and wherein said expressing of the approximate self-consistent solution or change in the self-consistent solution for the selected function is expressed for the selected value of the first selected external parameter and a selected value of the second selected external parameter by use of extrapolation based on at least the determined first and second self-consistent solutions together with the first and second values of the first selected external parameter, and further based on at least the determined fourth and fifth self-consistent solutions together with the first and second values of the second selected external parameter.

70. A method according to claim 69, wherein
a sixth self-consistent solution to the selected function is determined for a third value of the second selected external parameter by use of self-consistent loop calculation, said third value of the second selected external parameter being different to the first and second values of the second selected external parameter, and wherein
said expressing of the approximate self-consistent solution or change in the self-consistent solution for the selected function is expressed for the selected value of the first selected external parameter and the selected value of the second selected external parameter by use of extrapolation based on at least the determined first, second and third self-consistent solutions together with the first, second and third values of the first selected external parameter, and further based on at least the determined fourth, fifth and sixth self-consistent solutions together with the first, second and third values of the second selected external parameter.

71. A method according to claim 70, wherein the approximate self-consistent solution or change in the self-consistent solution is expressed by use of second order extrapolation.

72. A method according to claim 66, wherein the first value of the second selected external parameter is equal to the first value of the first selected external parameter.

73. A method according to claim 57, wherein the selected function is selected from the functions represented by: the effective one-electron potential energy function, the effective one-electron Hamiltonian, and the electron density.

74. A method according to claim 73, wherein the selected function is the effective one-electron potential energy function or the effective one-electron Hamiltonian and the self-consistent loop calculation is based on the Density Functional Theory, DFT, or the Hartree-Fock Theory, HF.

75. A method according to claim 57, wherein the self-consistent loop calculation is based on a loop calculation including the steps of:
a) selecting a value of the electron density for a selected region of the model of the system,
b) determining the effective one-electron potential energy function for the selected electron density and for a selected value of the external parameter,
c) calculating a value for the electron density corresponding to the determined effective one-electron potential energy function,
d) comparing the selected value of the electron density with the calculated value of the electron density, and if the selected value and the calculated value of electron density are equal within a given numerical accuracy, then
e) defining the solution to the effective one-electron potential energy function as the self-consistent solution to the effective one-electron potential energy function, and if not, then
f) selecting a new value of the electron density and repeat steps b)-f) until the selected value and the calculated value of electron density are equal within said given numerical accuracy.

76. A method according to claim 75, wherein the self-consistent solution to the effective one-electron potential energy function is determined for the probe or electrode regions of the system.

77. A method according to claim 76, wherein the selected function is the effective one-electron Hamiltonian for an interaction region of the system, and the determination of a second self-consistent solution to the effective one-electron Hamiltonian of the interaction region of the system comprises the step of calculating a corresponding self-consistent solution to the effective one-electron potential energy function for the interaction region at a given value of the first selected external parameter.

78. A method according to claim 77, wherein Green's functions are constructed or determined for each of the probe or electrode regions based on the corresponding determined self-consistent solution to the effective one-electron potential energy function.

79. A method according to claim 77, wherein determination of a second self-consistent solution to the effective one-electron Hamiltonian is based on a loop calculation including the steps of:
aa) selecting a value of the electron density for the interaction region of the system,
bb) determining the effective one-electron potential energy function for the selected electron density for a given value of the selected external parameter,
cc) determining a solution to the effective one-electron Hamiltonian for the interaction region based on the in step bb) determined effective one-electron potential energy function,
dd) determining a solution to Green's function for the interaction region based on the in step cc) determined solution to the effective one-electron Hamiltonian,
ee) calculating a value for the electron density corresponding to the determined Green's function for the interaction region,
ff) comparing the selected value of the electron density with the calculated value of the electron density, and if the selected value and the calculated value of electron density are equal within a given numerical accuracy, then
gg) defining the solution to the effective one-electron Hamiltonian as the self-consistent solution to the effective one-electron Hamiltonian, and if not, then
hh) selecting a new value of the electron density and repeat steps bb)-hh) until the selected value and the calculated value of electron density are equal within said given numerical accuracy.

80. A method according to claim 57, wherein the selected function is the effective one-electron Hamiltonian being represented by a Hamiltonian matrix with each element of said matrix being a function having an approximate self-consistent solution or a change in the self-consistent solution being expressed by use of a corresponding extrapolation expression.

81. A method according to claim 63, wherein the selected function is the effective one-electron Hamiltonian and the external parameter is a voltage bias across two probes of the system, an wherein a first and a second self-consistent solution is determined for the effective one-electron Hamiltonian for selected first and second values, respectively, of the external voltage bias, whereby an extrapolation expression is obtained to an approximate self-consistent solution for the effective one-electron Hamiltonian when the external voltage bias is changed, said method further comprising:
determining the electrical current between the two probes of the system for a number of different values of the applied voltage bias using the obtained extrapolation expression, which expresses the approximate self-consistent solution or change in the self-consistent solution for the effective one-electron Hamiltonian.

82. A method according to claim 81, wherein the electrical current is determined for a given range of the external voltage bias and for a given voltage step in the external voltage bias.

83. A method according to claim 82, wherein the electrical current is determined using the following loop:
aaa) determining the current for the lowest voltage within the given range of the external voltage bias,
bbb) increasing the voltage bias by the given voltage step,
ccc) determining the current for the new increased voltage bias,
ddd) repeating steps bbb) and ccc) until the new increased voltage bias is larger than the highest voltage of the given range of the voltage bias.

84. A method according to claim 63, wherein the selected function is the effective one-electron Hamiltonian and the external parameter is a voltage bias across two probes of the system, said method comprising:
dividing a determined voltage range for the external voltage bias in at least a first and a second voltage range,
determining for the first and second voltage ranges a maximum and a minimum self-consistent solution to the effective one-electron Hamiltonian corresponding to the maximum and minimum values of said voltage ranges,
obtaining a first extrapolation expression to the approximate self-consistent solution for the effective one-electron Hamiltonian when the external voltage bias is changed, said first extrapolation expression being based on the determined maximum and minimum self-consistent solutions for the first voltage range and the maximum and minimum voltage values of the first voltage range,
obtaining a second extrapolation expression to the approximate self-consistent solution for the effective one-electron Hamiltonian when the external voltage bias is changed, said second extrapolation expression being based on the determined maximum and minimum self-consistent solutions for the second voltage range and the maximum and minimum voltage values of the second voltage range,
determining the electrical current between the two probes of the system for a number of different values of the applied voltage bias within the voltage range given by the minimum and maximum voltage of the first voltage range using the obtained first extrapolation expression, and
determining the electrical current between the two probes of the system for a number of different values of the applied voltage bias within the voltage range given by the minimum and maximum voltage of the second voltage range using the obtained second extrapolation expression.

85. A method according to claim 84, wherein the determined voltage range is divided in at least three voltage ranges, said method further comprising:
determining for the third voltage range a maximum and a minimum self-consistent solution to the effective one-electron Hamiltonian corresponding to the maximum and minimum values of the third voltage range,
obtaining a third extrapolation expression to the approximate self-consistent solution for the effective one-electron Hamiltonian when the external voltage bias is changed, said third extrapolation expression being based on the determined maximum and minimum self-consistent solutions for the third voltage range and the maximum and minimum voltage values of the third voltage range, and
determining the electrical current between the two probes of the system for a number of different values of the applied voltage bias within the voltage range given by the minimum and maximum voltage of the third voltage range using the obtained third linear extrapolation.

86. A method according to claim 63, wherein the selected function is the effective one-electron Hamiltonian and the external parameter is a voltage bias across two probes of the system, an wherein a first and a second self-consistent solution is determined for the effective one-electron Hamiltonian for selected first and second values, respectively, of the external voltage bias, with said second value being higher than the selected first value of the voltage bias, whereby a first extrapolation expression is obtained to an approximate self-consistent solution for the effective one-electron Hamiltonian when the external voltage bias is changed, said method further comprising:
aaaa) selecting a voltage range having a minimum value and a maximum value for the external voltage bias in order to determine the electrical current between the two probes of the system for a number of different values of the applied voltage bias within said range,
bbbb) determining a maximum self-consistent solution to the effective one-electron Hamiltonian for the selected maximum value of the external voltage bias by use of self-consistent loop calculation,
cccc) determining the electrical current between the two probes of the system for the maximum value of the voltage bias based on the corresponding determined maximum self-consistent solution,
dddd) determining the electrical current between the two probes of the system for the selected maximum value of the voltage bias based on the obtained first extrapolation expression,
eeee) comparing the current values determined in steps cccc) and dddd), and if they are equal within a given numerical accuracy, then
ffff) determining the electrical current between the two probes of the system for a number of different values of the applied voltage bias within the voltage range given by the selected first voltage value and the maximum voltage value using an extrapolation expression for an approximate self-consistent solution for the effective one-electron Hamiltonian when the external voltage bias is changed.

87. A method according to claim 86, wherein a maximum extrapolation expression is obtained to the approximate self-consistent solution for the effective one-electron Hamiltonian, said maximum extrapolation expression being based on the determined first and maximum self-consistent solutions and the first voltage bias and the maximum value of the voltage bias, and wherein said maximum extrapolation expression is used when determining the current in step ffff).

88. A method according to claim 87, wherein when in step eeee) the current values determined in steps cccc) and dddd), are not equal within the given numerical accuracy, then
gggg) selecting a new maximum value of the external voltage bias between the first value and the previous maximum value,
hhhh) repeating steps bbbb) to hhhh) until the in steps cccc) and dddd) determined current values are equal within said given numerical accuracy.

89. A method according to claim 86, said method further comprising:
iiii) determining a minimum self-consistent solution to the effective one-electron Hamiltonian for the selected minimum value of the external voltage bias by use of self-consistent loop calculation,
jjjj) determining the electrical current between the two probes of the system for the minimum value of the voltage bias based on the corresponding determined minimum self-consistent solution,
kkkk) determining the electrical current between the two probes of the system for the selected minimum value of the voltage bias based on the obtained first extrapolation expression,
llll) comparing the current values determined in steps jjjj) and kkkk), and if they are equal within a given numerical accuracy, then
mmmm) determining the electrical current between the two probes of the system for a number of different values of the applied voltage bias within the voltage range given by the selected first voltage value and the minimum voltage value using an extrapolation expression for an approximate self-consistent solution for the effective one-electron Hamiltonian when the external voltage bias is changed.

90. A method according to claim 89, wherein a minimum extrapolation expression is obtained to the approximate self-consistent solution for the effective one-electron Hamiltonian, said minimum extrapolation expression being based on the determined first and minimum self-consistent solutions and the first voltage bias and the minimum value of the voltage bias, and wherein said minimum extrapolation expression is used when determining the current in step mmmm).

91. A method according to claim 89, wherein when in step llll) the current values determined in steps jjjj) and kkkk), are not equal within the given numerical accuracy, then
nnnn) selecting a new minimum value of the external voltage bias between the first value and the previous minimum value,
oooo) repeating steps iiii) to oooo) until the in steps jjjj) and kkkk) determined current values are equal within said given numerical accuracy.

92. A computer system for using extrapolation analysis to express an approximate self-consistent solution or a change in a self-consistent solution based on a change in the value of one or more external parameters, said self-consistent solution being used in a model of a nano-scale system having at least two probes or electrodes, which model is based on an electronic structure calculation comprising a self-consistent determination of an effective one-electron potential energy function and/or an effective one-electron Hamiltonian, said computer system comprising:
means for determining a first self-consistent solution to a selected function for a first value of a first external parameter by use of self-consistent loop calculation,
means for determining a second self-consistent solution to the selected function for a second value of the first selected external parameter by use of self-consistent loop calculation, said second value of the first selected external parameter being different to the first value of the first selected external parameter, and
means for expressing an approximate self-consistent solution or a change in the self-consistent solution for the selected function for at least one selected value of the first selected external parameter by use of extrapolation based on at least the determined first and second self-consistent solutions and the first and second values of the first selected external parameter.

93. A computer system according to claim 92, wherein the means for expressing the approximate self-consistent solution or change in the self-consistent solution is adapted for expressing such solution by use of linear extrapolation.

94. A computer system according to claim 92, said system further comprising:
means for determining a third self-consistent solution to the selected function for a third value of the first selected external parameter by use of self-consistent loop calculation, said third value of the first selected external parameter being different to the first and second values of the first selected external parameter, and wherein
the means for expressing the approximate self-consistent solution or change in the self-consistent solution for the selected function for at least one selected value of the first selected external parameter is adapted for expressing such solution by use of extrapolation based on at least the determined first, second and third self-consistent solutions and the first, second and third values of the first selected external parameter.

95. A computer system according to claim 94, wherein the means for expressing the approximate self-consistent solution or change in the self-consistent solution is adapted for expressing such solution by use of second order extrapolation.

96. A computer system according to claim 92, wherein the nano-scale system is a two-probe system and the external parameter is a voltage bias, U, across said two probes or electrodes, said two-probe system being modelled as having two substantially semi-infinite probes or electrodes being coupled to each other via an interaction region.

97. A computer system according to claim 92, wherein the nano-scale system is a three-probe system with three probes or electrodes and the external parameters are a first selected parameter and a second selected parameter being of the same type as the first selected parameter.

98. A computer system according to claim 97, wherein the nano-scale system is a three-probe system with three probes or electrodes and the external parameters are a first voltage bias, U1, across a first and a second of said electrodes and a second voltage bias, U2, across a third and the first of said electrodes, said three-probe system being modelled as having three substantially semi-infinite electrodes being coupled to each other via an interaction region.

99. A computer system according to claim 97, said computer system further comprising:
means for determining a fourth self-consistent solution to the selected function for a first value of the second selected external parameter by use of self-consistent loop calculation,
means for determining a fifth self-consistent solution to the selected function for a second value of the second selected external parameter by use of self-consistent loop calculation, said second value of the second selected external parameter being different to the first value of the second selected external parameter, and
wherein said means for expressing of the approximate self-consistent solution or change in the self-consistent solution for the selected function is adapted to express the approximate self-consistent solution for the selected value of the first selected external parameter and a selected value of the second selected external parameter by use of extrapolation based on the determined first and second self-consistent solutions together with the first and second values of the first selected external parameter, and further based on the determined fourth and fifth self-consistent solutions together with the first and second values of the second selected external parameter.

100. A computer system according to claim 99, wherein the means for expressing the approximate self-consistent solution or change in the self-consistent solution is adapted for expressing such solution by use of linear extrapolation.

101. A computer system according to claim 94, wherein the nano-scale system is a three-probe system with three probes or electrodes and the external parameters are a first selected parameter and a second selected parameter being of the same type as the first selected parameter.

102. A computer system according to claim 101, said computer system further comprising:
means for determining a fourth self-consistent solution to the selected function for a first value of the second selected external parameter by use of self-consistent loop calculation,
means for determining a fifth self-consistent solution to the selected function for a second value of the second selected external parameter by use of self-consistent loop calculation, said second value of the second selected external parameter being different to the first value of the second selected external parameter, and
wherein said means for expressing of the approximate self-consistent solution or change in the self-consistent solution for the selected function is adapted to express the approximate self-consistent solution for the selected value of the first selected external parameter and a selected value of the second selected external parameter by use of extrapolation based on the determined first and second self-consistent solutions together with the first and second values of the first selected external parameter, and further based on the determined fourth and fifth self-consistent solutions together with the first and second values of the second selected external parameter.

103. A computer system according to claim 102, said system further comprising:
means for determining a sixth self-consistent solution to the selected function for a third value of the second selected external parameter by use of self-consistent loop calculation, said third value of the second selected external parameter being different to the first and second values of the second selected external parameter, and wherein
the means for expressing the approximate self-consistent solution or change in the self-consistent solution for the selected function is adapted to express the approximate self-consistent solution for the selected value of the first selected external parameter and the selected value of the second selected external parameter by use of extrapolation based on at least the determined first, second and third self-consistent solutions together with the first, second and third values of the first selected external parameter, and further based on at least the determined fourth, fifth and sixth self-consistent solutions together with the first, second and third values of the second selected external parameter.

104. A computer system according to claim 103, wherein the means for expressing the approximate self-consistent solution or change in the self-consistent solution is adapted for expressing such solution by use of second order extrapolation.

105. A computer system according to claim 99, wherein the first value of the second selected external parameter is equal to the first value of the first selected external parameter.

106. A computer system according to claim 92, wherein the selected function is selected from the functions represented by: the effective one-electron potential energy function, the effective one-electron Hamiltonian, and the electron density.

107. A computer system according to claim 106, wherein the selected function is the effective one-electron potential energy function or the effective one-electron Hamiltonian and the self-consistent loop calculation is based on the Density Functional Theory, DFT, or the Hartree-Fock Theory, HF.

108. A computer system according to claim 92, further comprising means for performing a self-consistent loop calculation based on a loop calculation including the steps of:
a) selecting a value of the electron density for a selected region of the model of the nano-scale system,
b) determining the effective one-electron potential energy function for the selected electron density and for a selected value of the external parameter,
c) calculating a value for the electron density corresponding to the determined effective one-electron potential energy function,
d) comparing the selected value of the electron density with the calculated value of the electron density, and if the selected value and the calculated value of electron density are equal within a given numerical accuracy, then
e) defining the solution to the effective one-electron potential energy function as the self-consistent solution to the effective one-electron potential energy function, and if not, then
f) selecting a new value of the electron density and repeat steps b)-f) until the selected value and the calculated value of electron density are equal within said given numerical accuracy.

109. A computer system according to claim 108, wherein the means for performing the self-consistent loop calculation is adapted to determine the self-consistent solution to the effective one-electron potential energy function for the probe or electrode regions of the system.

110. A computer system according to claim 107, wherein the selected function is the effective one-electron Hamiltonian for an interaction region of the system, and the means for determining a second self-consistent solution to the effective one-electron Hamiltonian of the interaction region of the system is adapted to perform said determination by including the step of calculating a corresponding self-consistent solution to the effective one-electron potential energy function for the interaction region at a given value of the first selected external parameter.

111. A computer system according to claim 109, further comprising means for determining Green's functions for each of the probe or electrode regions based on the corresponding determined self-consistent solution to the effective one-electron potential energy function.

112. A computer system according to claim 110, wherein the means for determination of a second self-consistent solution to the effective one-electron Hamiltonian is adapted to perform said determination based on a loop calculation including the steps of:
aa) selecting a value of the electron density for the interaction region of the system,
bb) determining the effective one-electron potential energy function for the selected electron density for a given value of the selected external parameter,
cc) determining a solution to the effective one-electron Hamiltonian for the interaction region based on the in step b) determined effective one-electron potential energy function,
dd) determining a solution to Green's function for the interaction region based on the in step c) determined solution to the effective one-electron Hamiltonian,
ee) calculating a value for the electron density corresponding to the determined Green's function for the interaction region,
ff) comparing the selected value of the electron density with the calculated value of the electron density, and if the selected value and the calculated value of electron density are equal within a given numerical accuracy, then
gg) defining the solution to the effective one-electron Hamiltonian as the self-consistent solution to the effective one-electron Hamiltonian, and if not, then
hh) selecting a new value of the electron density and repeat steps bb)-hh) until the selected value and the calculated value of electron density are equal within said given numerical accuracy.

113. A computer system according to claim 96, wherein the selected function is the effective one-electron Hamiltonian and the external parameter is a voltage bias across two probes of the system, wherein the means for determining a first and a second self-consistent solution is adapted to perform said determination for the effective one-electron Hamiltonian for selected first and second values, respectively, of the external voltage bias, and wherein the means for expressing an approximate self-consistent solution by use of extrapolation analysis is adapted to obtain an extrapolation expression to an approximate self-consistent solution for the effective one-electron Hamiltonian when the external voltage bias is changed, said computer system further comprising:
means for determining the electrical current between the two probes of the system for a number of different values of the applied voltage bias using the obtained extrapolation expression, which expresses the approximate self-consistent solution or change in the self-consistent solution for the effective one-electron Hamiltonian.

114. A computer system according to claim 113, wherein the means for determining the electrical current is adapted to determine the electrical current for a given range of the external voltage bias and for a given voltage step in the external voltage bias.

115. A computer system according to claim 114, wherein the means for determining the electrical current is adapted to perform said determination using the following loop:
aaa) determining the current for the lowest voltage within the given range of the external voltage bias,
bbb) increasing the voltage bias by the given voltage step,
ccc) determining the current for the new increased voltage bias,
ddd) repeating steps bbb) and ccc) until the new increased voltage bias is larger than the highest voltage of the given range of the voltage bias.

116. A computer system according to claim 96, wherein the selected function is the effective one-electron Hamiltonian and the external parameter is a voltage bias across two probes of the system, said computer system further comprising:
means for dividing a determined voltage range of the external voltage bias in at least a first and a second voltage range,
means for determining for the first and second voltage ranges a maximum and a minimum self-consistent solution to the effective one-electron Hamiltonian corresponding to the maximum and minimum values of said voltage ranges,
means for obtaining a first extrapolation expression to the approximate self-consistent solution for the effective one-electron Hamiltonian when the external voltage bias is changed, said first extrapolation expression being based on the determined maximum and minimum self-consistent solutions for the first voltage range and the maximum and minimum voltage values of the first voltage range,
means for obtaining a second extrapolation expression to the approximate self-consistent solution for the effective one-electron Hamiltonian when the external voltage bias is changed, said second extrapolation expression being based on the determined maximum and minimum self-consistent solutions for the second voltage range and the maximum and minimum voltage values of the second voltage range,
means for determining the electrical current between the two probes of the system for a number of different values of the applied voltage bias within the voltage range given by the minimum and maximum voltage of the first voltage range using the obtained first extrapolation expression, and
means for determining the electrical current between the two probes of the system for a number of different values of the applied voltage bias within the voltage range given by the minimum and maximum voltage of the second voltage range using the obtained second extrapolation expression.
